(19) United States
(12) Patent Application Publication
(10) Pub. No.: US 2018/0084539 A1
(43) Pub. Date: Mar. 22, 2018

(54) USER EQUIPMENT CAPABILITY DETERMINATION FOR MULTIPLE RADIO CAPABILITY GROUPS

(71) Applicant: QUALCOMM Incorporated, San Diego, CA (US)

(72) Inventors: Keiichi Kubota, San Diego, CA (US); Gavin Bernard Horn, La Jolla, CA (US); Aziz Gholmieh, Del Mar, CA (US); Srinivasan Balasubramanian, San Diego, CA (US)

(21) Appl. No.: 15/708,880

(22) Filed: Sep. 19, 2017

Related U.S. Application Data
(60) Provisional application No. 62/397,909, filed on Sep. 21, 2016.
(60) Provisional application No. 62/446,635, filed on Jan. 16, 2017.

(51) Int. Cl. H04W 72/04; H04W 76/02

(52) U.S. Cl. CPC H04W 72/048; H04W 72/0453; H04W 72/0413; H04W 76/026

(57) ABSTRACT

LUE capability information is provided for coordination across multiple RATs or for single-RAT connectivity where UE capabilities may change or be reported according to capability groups. A base station may establish a first connection with a UE using a first RAT, and determine that the first connection is to be reconfigured, such as due to data transmission requirements exceeding the capacity of the currently configured connection. The base station may receive UE capability information, such as in response to a capability query transmitted to the UE. The base station may reconfigure the connection with the UE based on the UE capability response through initiating a second connection with a second base station using a second RAT, through reconfiguring the first connection, or combinations thereof.

### CROSS REFERENCES

The present Application for Patent claims priority to U.S. Provisional Patent Application No. 62/397,909 by Kubota, et al., entitled “Query-Based User Equipment Capability Determination For Coordination Across Multiple Radio Access Technologies,” filed Sep. 21, 2016, and to U.S. Provisional Application No. 62/446,635 by Kubota, et al., entitled “Query-Based User Equipment Capability Determination For Multiple Radio Capability Groups,” filed Jan. 16, 2017, assigned to the assignee hereof.

### INTRODUCTION

The following relates generally to wireless communication, and more specifically to user equipment capability determination for reconfigurations of a connection between a UE and a base station, for coordination across multiple radio access technologies (RATs), or any combination thereof.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as user equipment (UE).

These multiple access technologies include various different RATs that have been adopted in various telecommunication standards to provide a common protocol that enables different wireless devices to communicate on a municipal, national, regional, and even global level. An example of an emerging RAT telecommunication standard is new radio (NR, e.g., 5G radio access). NR is a set of enhancements to the LTE RAT promulgated by Third Generation Partnership Project (3GPP). It is designed to better support mobile broadband Internet access by improving spectral efficiency, lower costs, improve services, make use of new spectrum, and better integrate with other open standards using OFDMA with a cyclic prefix (CP) on the downlink (DL) and on the uplink (UL) as well as support beamforming, multiple-input multiple-output (MIMO) antenna technology, and carrier aggregation. Whenever a new RAT gets deployed, overlap with one or more existing RATs may necessitate coordination among the different RATs to efficiently serve various UEs. Efficient coordination among nodes of various different RATs may help to increase network efficiency and enhance user experience. Furthermore, as capability sets for UEs increase, reporting of UE capabilities may consume increasing resources.

### SUMMARY

A method of wireless communication is described. The method may include establishing a connection with a base station based at least in part on a first group of capabilities of the UE, the first group of capabilities being a full set of capabilities of the UE, identifying a second group of capabilities of the UE, the second group of capabilities of the UE being a subset of the first group of capabilities of the UE, and transmitting the second group of capabilities to the base station.

An apparatus for wireless communication is described. The apparatus may include means for establishing a connection with a base station based at least in part on a first group of capabilities of the UE, the first group of capabilities being a full set of capabilities of the UE, means for identifying a second group of capabilities of the UE, the second group of capabilities of the UE being a subset of the first group of capabilities of the UE, and means for transmitting the second group of capabilities to the base station.

Another apparatus for wireless communication is described. The apparatus may include a processor, memory in electronic communication with the processor, and instructions stored in the memory. The instructions may be operable to cause the processor to establish a connection with a base station based at least in part on a first group of capabilities of the UE, the first group of capabilities being a full set of capabilities of the UE, identify a second group of capabilities of the UE in response to the capability query, the second group of capabilities of the UE being a subset of the first group of capabilities of the UE, and transmit the second group of capabilities to the base station.

A non-transitory computer readable medium for wireless communication is described. The non-transitory computer-readable medium may include instructions operable to cause a processor to establish a connection with a base station based at least in part on a first group of capabilities of the UE, the first group of capabilities being a full set of capabilities of the UE, identify a second group of capabilities of the UE in response to the capability query, the second group of capabilities of the UE being a subset of the first group of capabilities of the UE, and transmit the second group of capabilities to the base station.

Some examples of the method, apparatus, and non-transitory computer-readable medium described above may further include processes, features, means, or instructions for receiving a connection reconfiguration message from the base station based at least in part on the second group of capabilities. Some examples of the method, apparatus, and non-transitory computer-readable medium described above may further include processes, features, means, or instructions for receiving a capability query from the base station for the second group of capabilities. Some examples of the method, apparatus, and non-transitory computer-readable medium described above may further include processes, features, means, or instructions for reconfiguring the connection with the base station to enable one or more capabilities of the second group of capabilities.

Some examples of the method, apparatus, and non-transitory computer-readable medium described above may further include processes, features, means, or instructions for transmitting an indication to the base station that the first group of capabilities of the UE is the full set of capabilities of the UE.

In some examples of the method, apparatus, and non-transitory computer-readable medium described above, the indication provides a number of capability groups that the UE can support. In some examples of the method, apparatus, and non-transitory computer-readable medium described above, the indication provides a number of capability groups that the UE can support and an indication of a type of capabilities of each capability group other than the first group of capabilities. In some examples of the method, apparatus, and non-transitory computer-readable medium described above, the full set of capabilities of the UE comprise a plurality of capability groups including one or more of UE capabilities per frequency band for a plurality of frequency bands, UE capabilities per data rate (e.g., UE category) for a plurality of data rates (e.g., UE categories), UE capabilities for one or more component carriers, or any combination thereof.

In some examples of the method, apparatus, and non-transitory computer-readable medium described above, the full set of capabilities of the UE further comprise one or more of a capability to semi-statically change one or more of the plurality of capability groups or a capability to dynamically change one or more of the plurality of capability groups.

In some examples of the method, apparatus, and non-transitory computer-readable medium described above, plurality of groups of capabilities may be mapped to an index, and the indication of the second group of capabilities includes an index value to indicate the second group of capabilities of the UE.

A method of wireless communication is described. The method may include establishing a connection with a UE based at least in part on a first group of capabilities of the UE, and receiving, from the UE, an indication of a second group of capabilities UE, the second group of capabilities being different from the first group of capabilities of the UE.

An apparatus for wireless communication is described. The apparatus may include means for establishing a connection with a UE based at least in part on a first group of capabilities of the UE, and means for receiving, from the UE, an indication of a second group of capabilities UE, the second group of capabilities being different from the first group of capabilities of the UE.

Another apparatus for wireless communication is described. The apparatus may include a processor, memory in electronic communication with the processor, and instructions stored in the memory. The instructions may be operable to cause the processor to establish a connection with a UE based at least in part on a first group of capabilities of the UE, and receive, from the UE, an indication of a second group of capabilities UE, the second group of capabilities being different from the first group of capabilities of the UE.

A non-transitory computer readable medium for wireless communication is described. The non-transitory computer-readable medium may include instructions operable to cause a processor to establish a connection with a UE based at least in part on a first group of capabilities of the UE, and receive, from the UE, an indication of a second group of capabilities UE, the second group of capabilities being different from the first group of capabilities of the UE.

Some examples of the method, apparatus, and non-transitory computer-readable medium described above may further include processes, features, means, or instructions for determining that the connection with the UE may be to be reconfigured based at least in part on the second group of capabilities of the UE. Some examples of the method, apparatus, and non-transitory computer-readable medium described above may further include processes, features, means, or instructions for transmitting a capability query to the UE for the second group of capabilities. Some examples of the method, apparatus, and non-transitory computer-readable medium described above may further include processes, features, means, or instructions for initiating the reconfiguration of the connection with the UE to enable one or more capabilities of the second group of capabilities.

Some examples of the method, apparatus, and non-transitory computer-readable medium described above may further include processes, features, means, or instructions for receiving an indication from the UE that the first group of capabilities may be less than the full set of capabilities of the UE.

In some examples of the method, apparatus, and non-transitory computer-readable medium described above, the indication provides a number of capability groups that the UE can support. In some examples of the method, apparatus, and non-transitory computer-readable medium described above, the indication provides a number of capability groups that the UE can support and an indication of a type of capabilities of each capability group other than the first group of capabilities. In some examples of the method, apparatus, and non-transitory computer-readable medium described above, the full set of capabilities of the UE comprise a plurality of capability groups including one or more of UE capabilities per frequency band for a plurality of frequency bands, UE capabilities per data rate (e.g., UE category) for a plurality of data rates (e.g., UE categories), UE capabilities for one or more component carriers, or any combination thereof. In some examples of the method, apparatus, and non-transitory computer-readable medium described above, the full set of capabilities of the UE further comprise one or more of a capability to semi-statically change one or more of the plurality of capability groups or a capability to dynamically change one or more of the plurality of capability groups.

In some examples of the method, apparatus, and non-transitory computer-readable medium described above, plurality of groups of capabilities may be mapped to an index, and the indication of the second group of capabilities includes an index value to indicate the second group of capabilities of the UE.

A method of wireless communication is described. The method may include establishing a first connection with a first base station using a first radio access technology (RAT), receiving a capability query for available resources for a reconfiguration procedure, determining a UE capability based at least in part on the first connection with the first base station, and transmitting the UE capability to the first base station.

In some examples of the method described above, the reconfiguration procedure comprises one or more of an establishment of a second connection with a second base station using a second RAT that may be different from the first RAT, an establishment of another connection with the first base station using the first RAT, or a reconfiguration of the first connection with the first base station using the first RAT.

Some examples of the method described above may further include processes, features, means, or instructions for establishing the second connection with the second base station using the second RAT. Some examples of the method described above may further include processes, features, means, or instructions for receiving a second capability query from the second base station. Some examples of the method described above may further include processes, features, means, or instructions for determining a second UE capability based at least in part on the first connection and the second connection. Some examples of the method described above may further include processes, features, means, or instructions for transmitting the second UE capability.

In some examples of the method described above, the transmitting the second UE capability comprises transmitting the second UE capability to the first base station, and wherein the second UE capability may be used for coordination with the second base station to reconfigure the second connection, or the second UE capability may be tunneled to the second base station via the first base station. In some examples of the method described above, the transmitting the second UE capability comprises transmitting the second UE capability to the second base station.

Some examples of the method described above may further include processes, features, means, or instructions for reconfiguring the second connection with the second base station. Some examples of the method described above may further include processes, features, means, or instructions for transmitting a modified UE capability to one or more of the first base station or second base station based at least in part on the first connection and the reconfigured second connection. In some examples of the method described above, the transmitting the modified UE capability comprises transmitting the modified UE capability to the first base station responsive to a third capability query received from the first base station.

In some examples of the method described above, the second capability query from the second base station may be received via the first base station using the first RAT. In some examples of the method described above, the reconfiguration procedure comprises at least one parameter change to any connection which may have already been established between the UE and a radio access network. In some examples of the method described above, the determining the UE capability comprises determining available UE resources based at least in part on a connected mode configuration of the UE across at least the first RAT and the second RAT.

In some examples of the method described above, the capability query comprises an indication of a type of a reconfiguration to be processed. In some examples of the method described above, the transmitting the UE capability comprises transmitting UE capabilities relevant to the type of reconfiguration given by the capability query. In some examples of the method described above, the capability query comprises a query of a specific UE capability related to a specific configuration indicated in the capability query. In some examples of the method described above, the transmitting the UE capability comprises transmitting UE capabilities relevant to the specific configuration indicated in the capability query.

A method of wireless communication is described. The method may include establishing a connection with a user equipment (UE) using the first RAT, determining that the connection with the UE is to be reconfigured, transmitting a capability query to the UE that queries for available resources for the reconfiguration, receiving a UE capability response from the UE, and initiating the reconfiguration of the connection with the UE.

In some examples of the method described above, the determining that the connection with the UE may be to be reconfigured comprises determining that the connection using the first RAT may be to be reconfigured. In some examples of the method described above, the determining that the connection with the UE may be to be reconfigured comprises determining that a second connection with a second base station using a second RAT may be to be established.

In some examples of the method described above, the initiating the reconfiguration of the connection with the UE comprises coordinating with the second base station to configure the second connection using the second RAT. In some examples of the method described above, the determining that the second connection with the second base station may be to be established comprises determining that data traffic between the first base station and the UE exceeds available capacity of the first base station.

Some examples of the method described above may further include processes, features, means, or instructions for receiving a modified UE capability from the UE that indicates UE capability for connections using the first RAT. Some examples of the method described above may further include processes, features, means, or instructions for receiving a notification from the second base station of a reconfiguration of the connection with the second base station. Some examples of the method described above may further include processes, features, means, or instructions for transmitting a second capability query to the UE. In some examples of the method described above, the modified UE capability may be received responsive to the second capability query.

In some examples of the method described above, the coordinating comprises providing the UE capability response corresponding to the second RAT to the second base station, and providing one or more of a data radio bearer (DRB) configuration, a flow configuration, or a security configuration for the connection with the second base station.

A method of wireless communication is described. The method may include coordinating with a first base station that has an established connection with a user equipment (UE) using the first RAT to establish a connection with the second base station using the second RAT, establishing the connection with the UE using the second RAT, determining that the connection using the second RAT is to be reconfigured, transmitting a capability query to the UE to determine UE resources for the reconfigured connection, receiving a capability query response from the UE, and reconfiguring the connection using the second RAT based at least in part on the capability query response.

In some examples of the method described above, the transmission of the capability query comprises tunneling the capability query to the UE through the connection with the first base station. In some examples of the method described above, the capability query comprises an indication of a type of a reconfiguration to be processed by the second base station for the reconfigured connection. In some examples of the method described above, the capability query response comprises UE capabilities relevant to the type of reconfiguration given by the capability query.

In some examples of the method described above, the capability query comprises a query of a specific UE capability related to a specific configuration. In some examples of the method described above, the UE capability response comprises UE capabilities relevant to the specific configuration indicated in the capability query. Some examples of the method described above may further include processes, features, means, or instructions for notifying the first base station of the reconfiguration of the connection with the second base station.

### BRIEF DESCRIPTION OF THE DRAWINGS

FIG. 1 illustrates an example of a system for wireless communication that supports UE capability determination for coordination across multiple RATs in accordance with aspects of the present disclosure.

FIG. 2 illustrates an example of a portion of a wireless communication system that supports UE capability determination for coordination across multiple RATs in accordance with aspects of the present disclosure.

FIG. 3 illustrates an example of another portion of a wireless communication system that supports UE capability determination for coordination across multiple RATs in accordance with aspects of the present disclosure.

FIG. 4 illustrates an example of another portion of a wireless communication system that supports UE capability determination for coordination across multiple RATs in accordance with aspects of the present disclosure.

FIG. 5 illustrates an example of another portion of a wireless communication system that supports UE capability determination for coordination across multiple RATs in accordance with aspects of the present disclosure.

FIG. 6A illustrates an example of another portion of a wireless communication system that supports UE capability determination for coordination across multiple RATs in accordance with aspects of the present disclosure.

FIG. 6B illustrates an example of another portion of a wireless communication system that supports UE capability determination for multiple radio capability groups in accordance with aspects of the present disclosure.

FIG. 7 illustrates an example of a process flow that supports UE capability determination for coordination across multiple RATs in accordance with aspects of the present disclosure.

FIG. 8 illustrates an example of a process flow that supports UE capability determination for connection reconfiguration of a single RAT in accordance with aspects of the present disclosure.

FIG. 9 illustrates an example of a process flow that supports UE capability determination for capability groups in accordance with aspects of the present disclosure.

FIGS. 10 through 12 show block diagrams of a device that supports UE capability determination for coordination across multiple RATs in accordance with aspects of the present disclosure.

FIG. 13 illustrates a block diagram of a system including a UE that supports UE capability determination for coordination across multiple RATs in accordance with aspects of the present disclosure.

FIGS. 14 through 19 show block diagrams of a device that supports UE capability determination for coordination across multiple RATs in accordance with aspects of the present disclosure.

FIG. 20 illustrates a block diagram of a system including a base station that supports UE capability determination for coordination across multiple RATs in accordance with aspects of the present disclosure.

FIGS. 21 through 29 illustrate methods for UE capability determination for coordination across multiple RATs in accordance with aspects of the present disclosure.

### DETAILED DESCRIPTION

Techniques are described that provide UE capability determination and reporting for coordination across multiple RATs or for single-RAT connectivity where UE capabilities may change or capability reporting may be performed based on capability groups. Such UE capability reporting may provide information on UE capabilities to a base station prior to a reconfiguration of a connection with the UE, in order to allow a base station to reconfigure the connection in accordance with the current UE capabilities. For example, a base station may establish a connection with a UE using a first RAT, and determine that the connection with the UE is to be reconfigured (e.g., due to data transmission requirements exceeding the capacity of the currently configured connection). The UE may transmit a capability indication that indicates capabilities of the UE that the base station may use in reconfiguring the connection with the UE. In some cases, the base station may transmit a capability query to the UE that queries for available resources for the reconfiguration and, responsive thereto, receive a UE capability response (e.g., a UE capability information message) from the UE. The capability query may include a UE capability enquiry message sent via RRC signaling, for example. The UE capability response may include a UE capability information message sent via RRC signaling, for example.

In some examples, an initial connection may be established using a first subset of UE capabilities, and the UE may report (e.g., responsive to a base station query) additional capabilities beyond the first subset of UE capabilities. In some cases, a UE may have multiple groups of UE capabilities, with an initial connection established using a first capability group, followed by one or more queries from a base station for UE capabilities of one or more other capability groups. The base station may reconfigure a connection based on one or more additional capabilities reported with the subsequence capability groups. In some cases, a UE and base station may establish a connection with a first group of capabilities that may enable a user of the UE to relatively quickly use some basic connectivity capabilities (e.g., a voice call or text message), with more enhanced features (e.g., enhanced mobile broadband (eMBB) using multiple component carriers) enabled following reporting of additional capability groups and reconfiguration based on the additional capability groups.

Based on the UE capability information, the base station may initiate a reconfiguration of the connection with the UE. In some cases, the reconfiguration may include at least one parameter change to any connection which has already been established between the UE and a radio access network. Some non-exhaustive examples of a reconfiguration may include coordinated multi-point (CoMP) configuration changes, carrier aggregation (CA) configuration/reconfiguration (e.g., secondary cell (SCell) addition, SCell change, or SCell removal), dual connectivity (DC) or multi-connectivity (MC) configuration/reconfiguration (e.g., secondary cell group (SCG) addition, SCG modification, SCG removal, primary SCell (PSCell) change, SCell change at secondary base station, SCell addition at secondary base station, SCell removal at secondary base station), or any combination thereof. In some examples, the reconfigured connection may provide one or more connections to one or more other radio access networks (RATs) that may use one or more other RATs, and the base station may coordinate with one or more base stations of the one or more other RANs (e.g., LTE, NR, wireless local area network (WLAN) RANs) to establish the connection(s) using the one or more other RATs.

Such UE capability reporting may help reduce the amount of coordination needed between base stations of different RATs. A RAN operating using a RAT thus requests UEs to provide the latest UE capability information before a reconfiguration procedure, and then the RAN determines what configuration should be applied for the reconfiguration procedure towards the UE. The UE capability query prior to a reconfiguration may take place per RAT and each RAT' s base station (e.g., eNB for LTE, gNB for NR) can confirm that its associated configuration will not exceed the UE capability. Such a capability determination may allow each RAT to configure connections without the need to comprehend other RAT configuration and capabilities. As used herein, a base station may refer to a RAN node that provides connectivity to one or more UEs, and may be referred to as an access node, a 5G or NR gNB, a 4G or LTE eNB, an eLTE eNB, a WLAN termination (WT), a 3G Node-B, or 2G base station, to name a few non-exhaustive examples.

The present disclosure describes various techniques with reference to next generation networks (e.g., 5G or NR networks) that are being designed to support features such as high bandwidth operations, more dynamic subframe types, and self-contained subframe types (in which hybrid automatic repeat request (HARD) feedback for a subframe may be transmitted before the end of the subframe). However, such techniques may be used for any system in which a base station may periodically reconfigure one or more connections with a UE, including systems where a UE may communicate using multiple different RATs as well as systems where a UE is communicating with only a single RAT but may have changing capabilities to support one or more connections to the single RAT (e.g., available UE resources may change over time due to the other activities in UE such as processor performance modification based on thermal status of the UE).

Aspects of the disclosure are initially described in the context of a wireless communications system. Aspects of the disclosure are further illustrated by and described with reference to diagrams, system diagrams, and flowcharts that relate to user equipment capability determination for coordination across multiple radio access technologies.

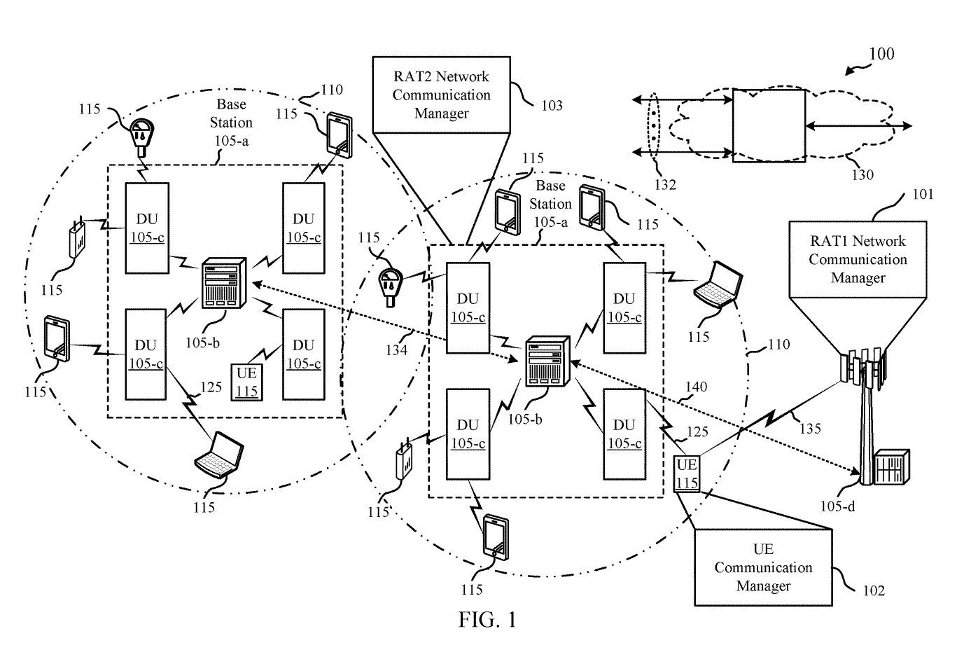

FIG. 1 illustrates an example of a wireless communication system 100, in accordance with various aspects of the disclosure. The wireless communication system 100 may include network devices 105, UEs 115, and a core network 130. Wireless communication system 100 may support UE 115 capability determination for coordination across multiple RATs or within a RAT. For example, wireless communication system 100 may support a capability query to a UE 115, and reconfiguration of one or more connections at the UE 115 based on a capability response of the UE 115. In some cases, a connection may be reconfigured to use a capability of a different capability group of a UE, or a new connection may be configured using one or more RATs across one or more network devices 105.

A core network 130 may provide user authentication, access authorization, tracking, Internet Protocol (IP) connectivity, and other access, routing, or mobility functions. At least some of the network devices 105 (e.g., network device 105-a, which may be an example of a LTE eNB, an eLTE eNB, an NR gNB, an NR Node-B, an NR access node or a base station, network device 105-b, which may be an example of an access node controller (ANC), or a centralized unit) may interface with the core network 130 through backhaul links 132 (e.g., S1, S2, NG-1, NG-2, NG-3, NG-C, NG-U etc.) and may perform radio configuration and scheduling for communication with the UEs 115. In various examples, the network devices 105-b may communicate, either directly or indirectly (e.g., through core network 130), with each other over backhaul links 134 (e.g., X1, X2, Xn etc.), which may be wired or wireless communication links.

Each network device 105-b may also communicate with a number of UEs 115 through a number of other network devices 105-c, where network device 105-c may be an example of a transmission reception point (TRP), a distributed unit (DU), a radio head (RH), a remote radio head (RRH), or a smart radio head. In alternative configurations, various functions of each network device 105 may be distributed across various network devices 105 (e.g., radio heads/distributed units and access network controllers/centralized units) or consolidated into a single network device 105 (e.g., a base station/an access node). In some examples, one or more other base stations 105-d of that operate using a different RAT than network devices 105-a through 105-c may be present in the wireless communication system 100 and may establish connections with one or more UEs 115.

In some examples, base station 105-d may operate according to a first RAT, and network devices 105-a through 105-c may operate according to a second RAT. For example, the first RAT may be an LTE (4G) RAT, an NR (5G) RAT or WLAN, and the second RAT may be an NR (5G) RAT, an LTE (4G) RAT or WLAN. Each RAT may establish one or more connections with one or more UEs 115 in the wireless communication system 100, with the first RAT communicating with UEs 115 via a first connection 135 and the second RAT communicating with UEs 115 via a second connection 135. In some examples, network device 105-d of the first RAT may communicate with one or more network devices 105 of the second RAT via backhaul link 140. While the first RAT in this example is a 4G or LTE RAT and the second RAT in this example is a 5G or NR RAT, it will be recognized that this is exemplary only, and that the techniques described herein may apply to any different types RATs, and any different type of RAT may be either the first RAT or the second RAT.

The wireless communication system 100 may support synchronous or asynchronous operation. For synchronous operation, the network devices 105-a and/or network devices 105-c may have similar frame timing, and transmissions from different network devices 105-a and/or network devices 105-c may be approximately aligned in time. For asynchronous operation, the network devices 105-a and/or network devices 105-c may have different frame timings, and transmissions from different network devices 105-a and/or network devices 105-c may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or one of the layer 2 protocol stack (e.g. Packet Data Convergence Protocol (PDCP)) may be IP-based. One of the layer 2 protocol stack (e.g. PDCP, Radio Link Control (RLC) or Medium Access Control (MAC)) may in some cases perform packet segmentation and reassembly to communicate over logical channels. One of the layer 2 protocol stack (e.g. A Medium Access Control (MAC)) may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and a network device 105-c, network device 105-b, or core network 130 supporting radio bearers for user plane data. At the Physical (PHY) layer, transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, a IoE device, a smart phone, a smart watch, a customer premises equipment (CPE) or the like. A UE may be able to communicate with various types of network devices 105-a, network devices 105-c, base stations, access points, or other network devices, including macro eNBs, small cell eNBs, relay base stations, and the like. A UE may also be able to communicate directly with other UEs (e.g., using a peer-to-peer (P2P) protocol).

The communication links 125 and 135 shown in wireless communication system 100 may include uplink (UL) channels from a UE 115 to a network device 105, and/or DL channels, from a network device 105 to a UE 115. The downlink channels may also be called forward link channels, while the uplink channels may also be called reverse link channels. Control information and data may be multiplexed on an uplink channel or downlink according to various techniques. Control information and data may be multiplexed on a downlink channel, for example, using TDM techniques, FDM techniques, or hybrid TDM-FDM techniques. In some examples, the control information transmitted during a TTI of a downlink channel may be distributed between different control regions in a cascaded manner (e.g., between a common control region and one or more UE-specific control regions).

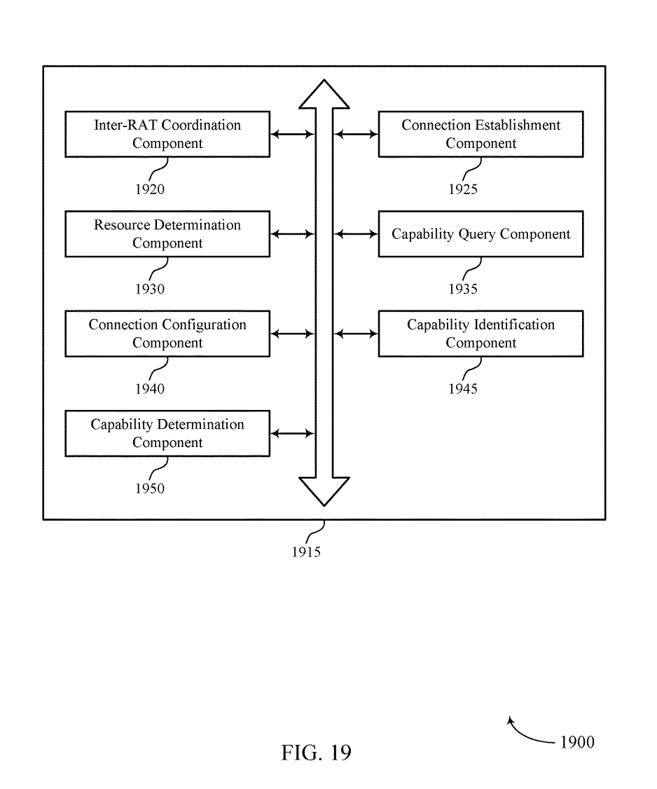

In the example of FIG. 1, base station 105-d of the first RAT may include a RAT1 network communication manager 101, which may establish a first connection with a UE 115 using the first RAT. The network communication manager 101 may determine that the first connection with the UE 115 is to be reconfigured (e.g., due to a capacity of the first connection not meeting current needs of the UE 115, or to enable a capability of a different UE 115 capability group), and may reconfigure the connection based on UE 115 capabilities, which may be reported by the UE 115. In some cases, one or more UEs 115 may transmit capability information autonomously. In other cases, the RAT1 network communication manager 101 may transmit a capability query to the UE 115 that queries for available resources for the reconfiguration or capabilities of a different capability group at the UE 115. The UE 115 may provide a UE capability response, and the network communication manager 101 may initiate the reconfiguration of the connection with the UE 115. Such a reconfiguration may include, for example, reconfiguring the first connection with the first RAT (e.g., by adding another component carrier (CC) that uses the first RAT), initiating the configuration of one or more new connection(s) with the second RAT while maintaining the first connection, initiating the configuration of one or more new connection(s) with the second RAT and/or one or more other RATs, and reconfiguring or discontinuing the first connection, or any combination thereof. The RAT1 network communication manager 101 may be an example of a base station communications manager 1915 as described below with reference to FIG. 19.

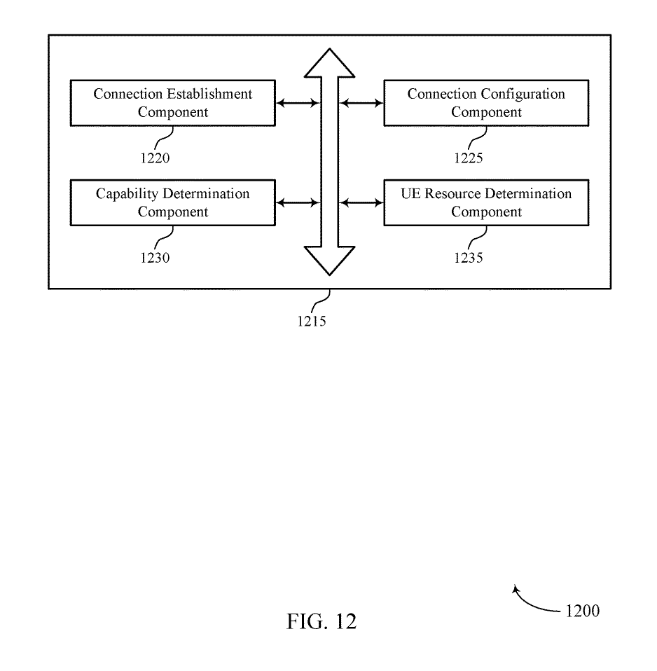

UEs 115 may include a UE communication manager 102, which may establish a first connection with a first network device 105-c using a first RAT, and report UE 115 capabilities for potential connection reconfiguration. In some cases, the UE communication manager 102 may receive a capability query for available resources for a reconfiguration procedure. The UE communication manager 102 may determine a UE 115 capability based at least in part on the first connection with the first network device 105-c, and transmit the UE capability to the first network device 105-c. In some cases, the UE communication manager 102 may determine and report UE 115 capabilities for one or more UE capability groups (e.g., based on a mapping between capability groups and a capabilities index). The first network device 105-c may receive the UE capability and initiate a reconfiguration of the connection with the UE 115, such as by reconfiguring the first connection, coordinating with a second network device 105-d to establish a second connection using a second RAT, or any combination thereof. The UE communication manager 102 may be an example of a UE communications manager 1215 as described below with reference to FIG. 12.

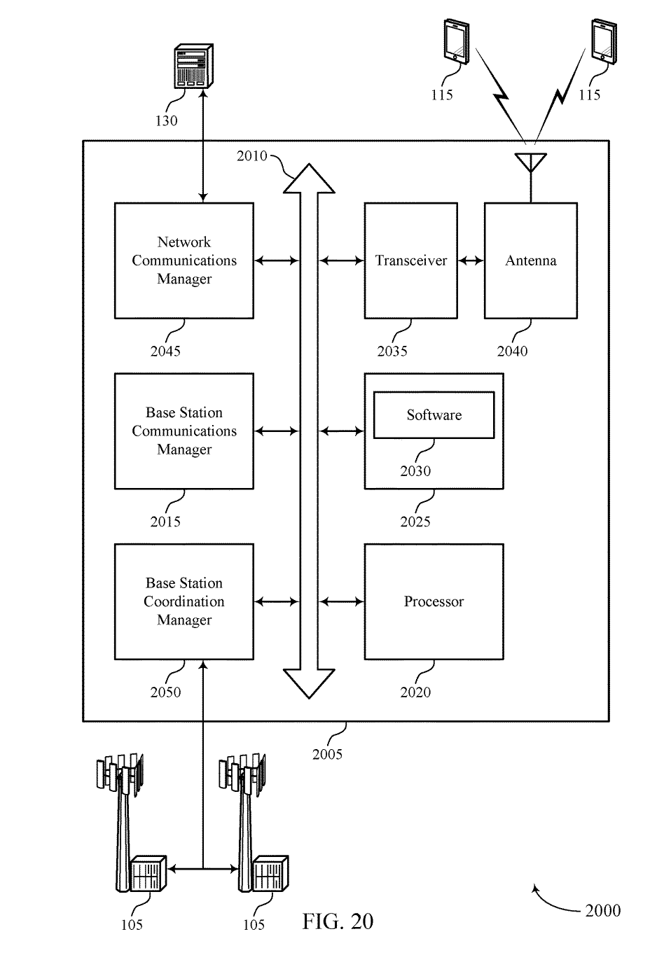

One or more of network devices 105-a of the second RAT may include a RAT2 network communication manager 103, which may coordinate with a first network device of the first RAT that has an established connection with a UE using the first RAT to establish a second connection with the UE 115 using the second RAT. In some cases, the RAT2 network communication manager 103 may determine that the second connection is to be reconfigured (e.g., due to changing amounts of data to be transmitted to/from the UE 115), and may transmit a capability query to the UE 115 to determine UE resources for the reconfigured connection. The RAT2 network communication manager 103 may receive a capability query response from the UE 115, and reconfigure the second connection based at least in part on the capability query response. In some examples, the RAT2 network communication manager 103 may coordinate with the RAT1 network communication manager 101 to provide notice that the second connection has been reconfigured, and the RAT1 network communication manager 101 may provide UE 115 capabilities (e.g., based on a prior capabilities report or a query to the UE 115 for its current capability so as to have the most recent UE 115 capability) that may be needed for a subsequent reconfiguration of the first connection. The RAT2 network communication manager 103 may be an example of a base station communications manager 2015 as described below with reference to FIG. 20.

Wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers. Wireless communication system 100 may also support multiple-input multiple-output (MIMO) operation in which multiple concurrent transmissions may share time and frequency resources, and may uniquely modulate a transmission stream with space-time orthogonal codes, such as spatial frequency block codes (SFBC). These spatial resources may be called transmission layers, and the same or different streams of data may be transmitted over different transmission layers. For single-user MIMO (SU-MIMO), multiple transmission layers may be transmitted to the same UE, while in multiple user (MU-MIMO), multiple transmission layers may be transmitted to different UEs. A capability reported by a UE 115 may take into account the RF chains available at the UE 115 based on such multi-carrier or MIMO operation.

In some cases, wireless communication system 100 may utilize enhanced component carriers (eCCs). An eCC may be characterized by one or more features including: wider bandwidth, shorter symbol duration, and shorter transmission time interval (TTIs). In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 Mhz, etc.) at reduced symbol durations (e.g., 16.67 microseconds). A TTI in eCC may consist of one or multiple symbols. In some cases, the TTI duration (that is, the number of symbols in a TTI) may be variable. A 5G or NR carrier may be considered an eCC.

Wireless communication system 100 may operate in an ultra high frequency (UHF) frequency region using frequency bands from 700 MHz to 2600 MHz (2.6 GHz), although in some cases wireless local area network (WLAN) networks may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communication system 100 may also utilize extremely high frequency (EHF) portions of the spectrum (e.g., from 30 GHz to 300 GHz). This region may also be known as the millimeter band, since the wavelengths range from approximately one millimeter to one centimeter in length, and systems that use this region may be referred to as millimeter wave (mmWave) systems. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions. Techniques disclosed herein may be employed across transmissions that use one or more different frequency regions.

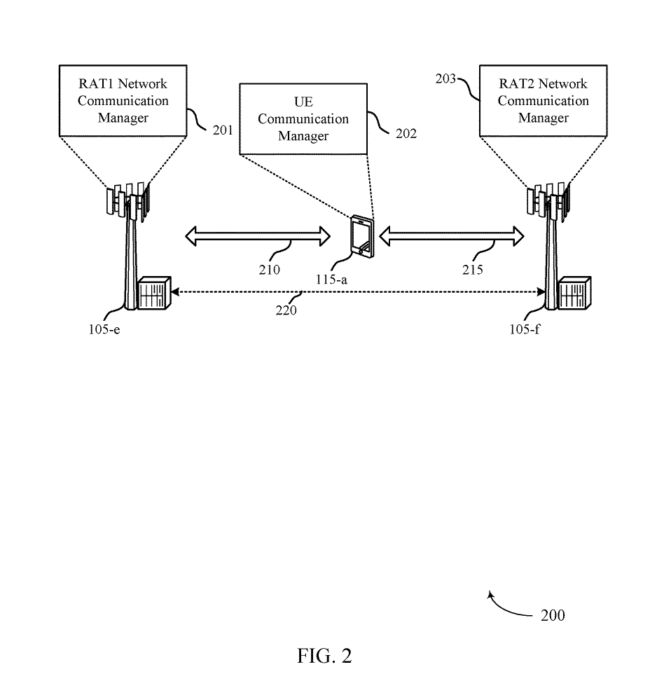

FIG. 2 illustrates an example of a portion of a wireless communication system 200 for UE capability determination for coordination across multiple RATs. Wireless communication system 200 may include a first base station 105-e, a second base station 105-f, and a UE 115-a, which may be examples of the corresponding devices described with reference to FIG. 1. In the example of FIG. 2, the first base station 105-e may operate according to a first RAT, such as a 4G or LTE RAT, and the second base station 105-f may operate according to a second RAT, such as a 5G or NR RAT, although techniques described herein may be applied to any RAT.

In some examples, the first base station 105-e may include a RAT1 network communication manager 201, which may be an example of RAT1 network communication manager 101 of FIG. 1, and may be used to establish a first connection 210 with UE 115-a. The RAT1 network communication manager 201 also may determine that the first connection 210 is to be reconfigured, and may initiate a reconfiguration of the first connection 210.

The UE 115-a may include a UE communication manager 202, which may be an example of UE communication manager 102 of FIG. 1, and may be used to establish the first connection 210 with the first base station 105-e and provide UE capability information to the first base station 105-e. The UE communication manager 202 also may receive capability requests and respond to capability requests that may be received from either the first base station 105-e or the second base station 105-f, and reconfigure one or more connections based on reconfigurations received from either the first base station 105-e or the second base station 105-f.

The second base station 105-f may include a RAT2 network communication manager 203, which may be an example of RAT2 network communication manager 103 of FIG. 1, and may be used to establish a second connection 215 with UE 115-a. The RAT2 network communication manager 203 also may determine that the second connection 215 is to be reconfigured, and may initiate a reconfiguration of the second connection 215. In some examples, the first base station 105-e may initiate the initial configuration of the second connection 215 through coordination with the second base station 105-f, and may communicate with the second base station 105-f via a backhaul link 220 (e.g., an Xn interface).

The coordination between the first base station 105-e and the second base station 105-f may be accomplished with varying degrees of interworking between the two different RANs. In some examples, there may be little or no coordination between the first base station 105-e and the second base station 105-f. In such cases, each base station 105 may independently configure connections with the UE 115-a. However, in such cases, there may be ping-pong reconfigurations across RATs, and the network does not have control of UE 115-a resources split across RATs.

In other examples, the first base station 105-e and the second base station 105-f may coordinate with each other using abstract capability and configuration dependencies using UE 115-a capability sets, in which a number of possible UE configurations are mapped to UE capability sets and the first base station 105-e and the second base station 105-f may exchange a particular configuration for the UE 115-a by identifying the UE capability in the UE capability sets. In such examples, each of the first base station 105-e and the second base station 105-f do not need to comprehend any configuration/capability of the other RAT but just needs to exchange the index of the sets. Using such coordination, ping-pong reconfiguration across RATs may be avoided, and the network has some choices for UE resource split across the RATs. In such examples, there is a trade-off between the ability to finely express the resource split at a UE between RATs, and the number of sets.

In further examples, the first base station 105-e and the second base station 105-f may coordinate with each other using coordination with explicit capability/configuration dependencies. In such cases, the first base station 105-e and the second base station 105-f may exchange information on UE 115-a configurations, and coordinate any reconfiguration of UE 115-a resources. Such reconfigurations may provide a semi-static capability split UE resources based on network coordination, and may provide flexibility to split the UE 115-a capabilities across the RATs. However, in such examples, evolution of each different RAT needs to be coordinated with other RATs in order to provide support for joint coordination of UE 115-a capabilities. In such examples, the first base station 105-e (e.g., an LTE eNB) may send a capability query to the UE 115-a, and the UE 115-a may signal its overall capabilities to the first base station 105-e. The first base station 105-e and the second base station 105-f may coordinate the configurations via full RAT specific configuration across RATs using backhaul link 220. The second base station 105-f may then configure the UE 115-a for communications using the second RAT according to the outcome of the coordination, and the first base station 105-e may configure UE 115-a for communications using the first RAT according to the outcome of the coordination.

In some examples provided herein, a reduced amount of coordination between the first base station 105-e and the second base station 105-f may be used to provide some network control over the split of UE 115-a resources between different RATs. In some examples, the first base station 105-e may request the UE 115-a to provide its latest capability information before a reconfiguration procedure, and then the first base station 105-e may determine what new configuration should be applied for the reconfiguration procedure towards the UE 115-a. The new configuration may include a reconfigured first connection 210, a newly established second connection 215, or combinations thereof. In cases where the new configuration involves a newly established second connection 215, the first base station 105-e may coordinate with the second base station 105-f (and/or one or more other base stations of one or more other RATs) to split the UE 115-a resources. At a later point, either the first base station 105-e or the second base station 105-f may determine that a further reconfiguration of connections at the UE 115-a is to be initiated, and initiate the further reconfiguration based on the reported UE 115-a capability (e.g., which may be reported periodically or reported responsive to a capability query). The UE capability query may be transmitted prior to a reconfiguration on a per-RAT basis, and each RAT' s base station 105 (e.g., eNB for LTE; gNB for NR) can confirm the configuration will not exceed the UE capability without needing explicit coordination with the other base station(s) 105.

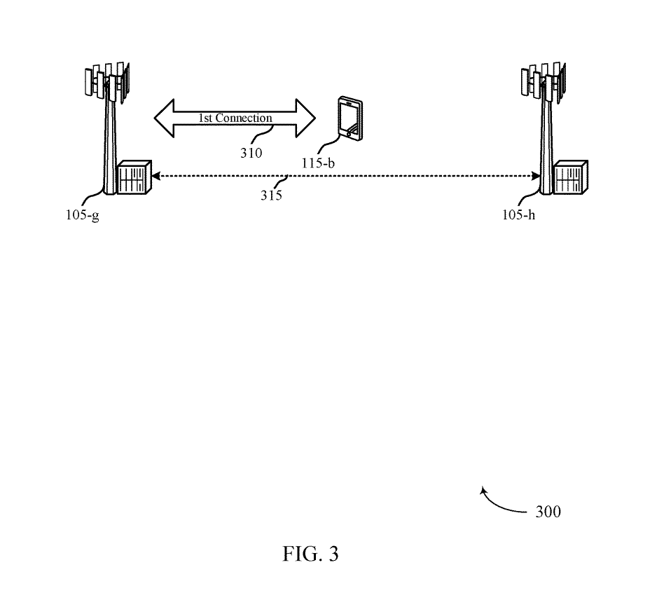

FIGS. 3 through 6 illustrate examples of a wireless communications system that may support connections between a UE and one or more base stations. Initially, FIG. 3 illustrates a portion of a wireless communication system 300 for UE capability determination for coordination across multiple RATs, which may include a first base station 105-f that operates according to a first RAT and a second base station 105-f that operates according to a second RAT. A UE 115-b may be capable of communications using either the first RAT, the second RAT, or concurrent connections with both the first RAT and the second RAT. The first base station 105-g, second base station 105-h, and UE 115-b, may be examples of the corresponding devices described with reference to FIGS. 1-2.

In the example of FIG. 3, the UE 115-b may establish a first connection 310, which may be a radio resource control (RRC) connection with the first at RAT1 (e.g., LTE), with the first base station 105-g. The UE 115-b may provide the overall UE capability information during the RRC connection establishment procedure to the first base station 105-g, which may use the capability information to periodically identify whether the first connection 310 continues to provide sufficient resources for communications of the UE 115-b. The first base station 105-g may have a backhaul connection 315 with the second base station 105-h, which may be used to coordinate potential connections between the UE 115-b and the second base station 105-h using the second RAT. The first base station 105-g may determine that a second connection should be established with the second base station 105-h, for example, such as when data traffic to/from the UE 115-b requires more bandwidth than the first base station 105-g is able to provide. In such a case, the first base station 105-g may transmit a capability query to the UE 115-b and may use a capability response from the UE 115-b to initiate a connection reconfiguration at the UE 115-b. The UE 115-b may determine UE capability information by taking into account the available resources (e.g., RF chains, memory) and/or the current UE status (e.g., CPU load, temperature of the device), and report the determined UE capability information. In some cases, the first base station 105-g may initiate the connection reconfiguration based on prior reported UE 115-b capabilities, and may not transmit a capability query to the UE 115-b.

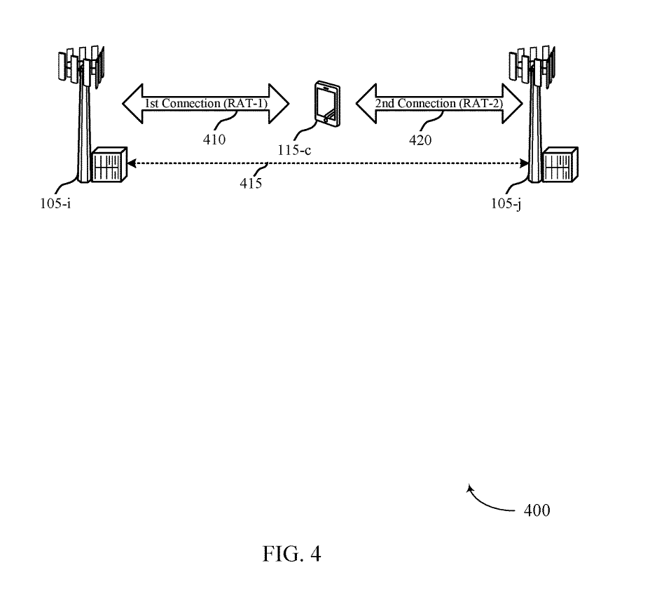

FIG. 4 illustrates a portion of a wireless communication system 400 for UE capability determination for coordination across multiple RATs that has a second connection 420 between a UE 115-c and a second base station 105-j that uses the second RAT. The wireless communication system 400 also includes first base station 105-i that operates according to the first RAT. The first base station 105-i, second base station 105-j, and UE 115-c, may be examples of the corresponding devices described with reference to FIGS. 1-3.

In this example, the second connection 420 may be established with the second base station 105-j following coordination between the first base station 105-i and the second base station 105-j through backhaul connection 415. As indicated above, the first base station 105-i may determine that the first connection 410 with the first base station 105-i may need to be reconfigured, transmit a capability query to the UE 115-c and receive the capability response back form the UE 115-c. Based on the capability response, the first base station 105-i may coordinate with the second base station 105-j via backhaul connection 415 to initiate the establishment of the second connection 420 using the second RAT. In some examples, the first base station 105-i may deliver information related to the UE 115-c, including, for example, one or more of a data radio bearer (DRB) configuration, a flow configuration, or a security configuration for the connection with the second base station 105-j. and also the UE 115-c capability information corresponding to the second RAT. The first base station 105-i and the second base station 105-j may then reconfigure the UE 115-c with the second connection 420.

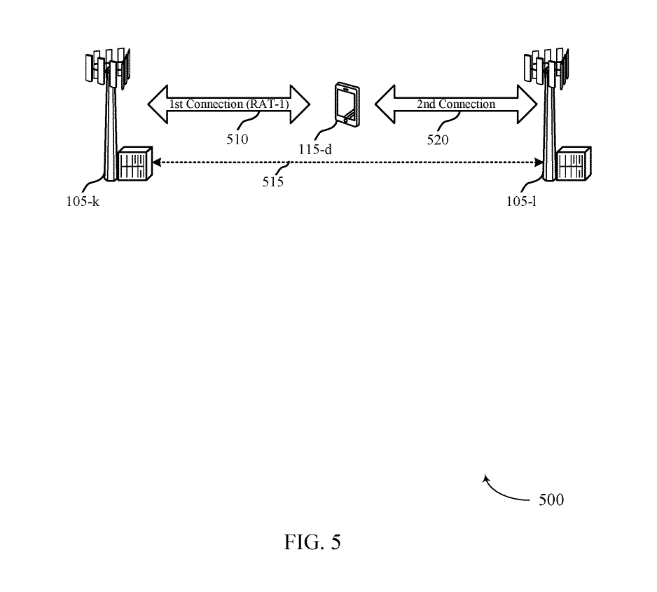

At some point, the second base station 105-j may determine that the second connection 420 should be reconfigured (e.g., due to changing data traffic at the UE 115-c). FIG. 5 illustrates a portion of a wireless communication system 500 for UE capability determination for coordination across multiple RATs that has a reconfigured second connection 520 between a UE 115-d and a second base station 105-l that uses the second RAT. The wireless communication system 500 also includes first base station 105-k that operates according to the first RAT. The first base station 105-k, second base station 105-l, and UE 115-d, may be examples of the corresponding devices described with reference to FIGS. 1-4.

As indicated above, in the event that the second connection is to be reconfigured, the second base station 105-l may transmit a UE capability query to the UE 115-d, such as when the second base station 105-l determined that data traffic with the UE 115-d requires more bandwidth, for example. The UE 115-d determines the UE capability information by taking into account the available UE resources (e.g., RF chains, memory) and/or the current UE status (e.g., CPU load, temperature of the device), and provide the UE capability information to the second base station 105-l. The second base station 105-l may then reconfigure the second connection 520 with the UE 115-d using the second RAT. In some examples, following the reconfiguration of the second connection 520, the UE 115-d may transmit new UE capability information, including its latest first RAT capability information, to the first base station 105-k via the first connection 510. In some examples, the first connection 510 may include multiple connections (e.g., connections using multiple CCs, connections to multiple base stations using CoMP techniques or connections via dual/multi-connectivity, etc.), and the UE 115-d may signal the new UE capability information towards every single serving base station to indicate the latest UE 115-a capability. In some examples, the new UE capability information may be transmitted only if it is different from the latest reported UE capability previously provided. In certain examples, the second base station 105-l may transmit an indication of the reconfiguration of the second connection 520 to the first base station 105-k (and one or more other base stations that have a connection with the UE 115-a) via backhaul connection 515, and the first base station 105-k may transmit a capability query to the UE 115-d to obtain the new UE capability.

In some examples, the UE capability query transmitted by either the first base station 105-k or the second base station 105-l may include information related to the type of information that is being requested. For example, the capability query may include a reconfiguration type information, that indicates what type of reconfiguration the base station 105 is planning to do after receiving the UE capability information, and the UE 115-d may report just the information relevant to the indicated type of reconfiguration. In such a manner, the overhead related to the capability queries and associated capability responses may be reduced.

In other examples, the UE capability query may include additional information that may indicate network capability or the configuration to be done by the network, such as number of component carriers supported or to be configured by the network. The UE 115-d may, in response to receiving such a capability query, provide UE capability information that will not exceed the given additional information (i.e., the network capability/configuration to be configured). Thus, a RAN may signal a preference for a number of CCs in a CA configuration at the RAT, for example.

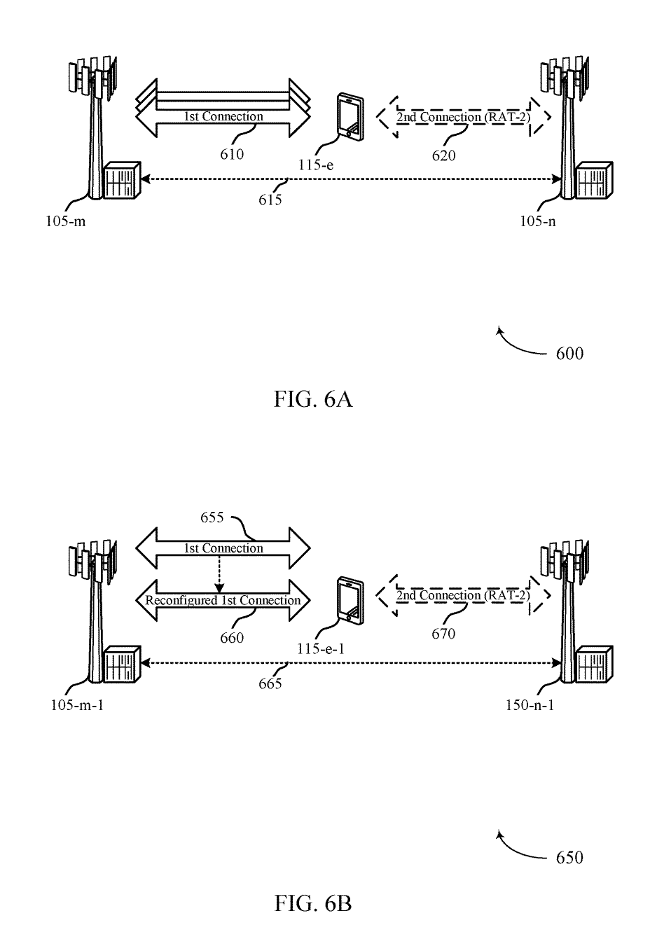

FIG. 6A illustrates a portion of a wireless communication system 600 for UE capability determination for coordination across multiple RATs that has different connections between a first base station 105-m, a second base station 105-n, and a UE 115-e. The first base station 105-m, second base station 105-n, and UE 115-e, may be examples of the corresponding devices described with reference to FIGS. 1-5. The first base station 105-m and second base station 105-n may be connected via backhaul connection 615.

While the above examples show various cases in which first and second connections may be established and reconfigured, it will be understood that such examples are provided for purposes of illustration and discussion and that numerous other examples of different connections using different RATs may be established and/or reconfigured according to the techniques provided herein. One such example is illustrated in FIG. 6A, where the first base station 105-m and the UE 115-e may reconfigure the first connection 610. An initial first connection (e.g., first connection 310 of FIG. 3) may be established over a first CC. In this example, the first connection 610 may be reconfigured, such as through one or more additional CCs that may be configured for communications with the first base station 105-m using the first RAT. In some examples, such a reconfiguration of the first connection 610 may be made after a second connection 620 is established (or after the second connection 620 is reconfigured) with second base station 105-n. The first base station 105-m may, similarly as discussed above, reconfigure the first connection 610 following a capability query to the UE 115-e.

In some cases, the first base station 105-m may not coordinate in the configuration of any second connection 620, or communicate with the second base station 105-n, and may only manage connections with the UE 115-e using the first RAT. In such a single-connectivity case, the first base station 105-m may still transmit a capability query to the UE 115-e to determine the UE's 115-e current capability prior to initiating the reconfiguration of the first connection 610. Such a procedure may allow the first base station 105-m to account for the most up to date UE 115-e capability information, which may change due to, for example, other activities in UE. In some examples, the other activities may include other connections to other RATs such as 5G or NR RATs, 4G or LTE RATs, Wi-Fi RATs, 3G, WCDMA or HSPA RATs, 2G or GSM RATs etc., that are not coordinated with the first base station 105-m, or other activities such as CPU performance degradation due to thermal addition at the device that may impact UE 115-e capability.

FIG. 6B illustrates a portion of a wireless communication system 650 for UE capability determination for multiple capability groups for connections between a first base station 105-m-1, an optional second base station 105-n-1, and a UE 115-e-1. The first base station 105-m-1, second base station 105-n-1, and UE 115-e-1, may be examples of the corresponding devices described with reference to FIGS. 1-6A. The first base station 105-m-1 and second base station 105-n-1 may be connected via backhaul connection 665.

While the above examples show various cases in which first and second connections may be established and reconfigured, it will be understood that such examples are provided for purposes of illustration and discussion and that numerous other examples of different connections using different RATs may be established and/or reconfigured according to the techniques provided herein. One such example is illustrated in FIG. 6B, where the first base station 105-m-1 and the UE 115-e-1 may reconfigure the first connection 655. An initial first connection (e.g., first connection 310 of FIG. 3) may be established over a first CC. In this example, the first connection 655 may be reconfigured, such as through one or more additional CCs that may be configured for communications with the first base station 105-m-1 using the first RAT.

The first base station 105-m-1 may, similarly as discussed above, reconfigure the first connection 655 following a capability query to the UE 115-e-1. In some cases, the first base station 105-m-1 may only manage connections with the UE 115-e using the first RAT. Additionally or alternatively, the first base station 105-m-1 may coordinate with second base station 105-n-1 (and/or other base stations) to establish one or more connections with one or more other RATs, in a manner similarly as discussed above. In such a single-connectivity case, the first base station 105-m-1 may still transmit a capability query to the UE 115-e-1 to determine the UE's 115-e-1 current capability prior to initiating the reconfiguration of the first connection 655.

In some cases, the first connection 655 may be established using a first capability group of the UE 115-e-1. In some cases, the first capability group may be a minimal UE capability that may allow operation on a single PCC frequency with a base set of capabilities that may allow a user to perform some tasks (e.g., a voice call or text message). Such an initial connection may provide faster connections when UE 115-e-1 relative to cases where a complete capability report for UE 115-e-1 may be provided before establishing a connection. With increasing RATs and combinations of features, an initial report of each UE 115-e-1 capability may result in UE 115-e-1 having to report a relatively large UE capability to the network. This both takes time to prepare having to read the overheads and reporting by the network and also preparing all the relevant combinations based on UE 115-e-1 capabilities accounting for the OEM configurations on the device. In cases, where such a report is performed when an initial connection is established, or on a current network request, this information may be prepared in real-time at the point of attach to the network. This may cause delays to the time the UE 115-e-1 is made available to the user. For example, if a user wishes to power on or enable the radio on the UE 115-e-1 after a plane lands, full capability reporting may cause a relatively long delay before the user is able to make a voice call or send a quick text message.

Capability reporting using capability groups, such as discussed herein, may allow for the UE 115-e-1 capability query from the network to be done in stages with the initial capability query focusing on getting the UE 115-e-1 camped on a cell to allow a user of the device to start using the regular cell phone services. In such cases, a first UE capability group may be defined that provides a minimal UE 115-e-1 capability information to allow operation on a single PCC frequency and with a reduced subset of capabilities relative to a full set of UE 115-e-1 capabilities. In some cases, the UE 115-e-1 may provide an indication, as part of an initial connection establishment process or as a separate indication following connection establishment, that the first capability group of the UE 115-e-1 is less than the full UE capabilities. One or more further queries of the UE 15-e-1 capabilities may be transmitted, with the stages of reporting indicated with acknowledgment of the individual stages to the UE 115-e-1 from the first base station 105-m-1. The first base station 105-m-1 may be limited to the current set of reported UE 115-e-1 capability independent of the stage, in some cases.

In some examples, the first base station 105-m-1 may have the ability to query certain groups, such as all capability groups, or capability groups with certain capability descriptors associated with one or more subsets of UE capabilities. Such subsets of UE capabilities may include, for example, per frequency band capabilities (e.g., Low, Medium, High, mm wave), per data rate capabilities (e.g., highest, lowest), per number of component carriers capabilities (e.g., 1, 2, highest possible), etc. In some cases, capability groups may have semi-static capabilities (e.g., capabilities are unchanged in the middle of a connection), or dynamic capabilities (e.g., capabilities may be changed in the middle of the connection).

In some cases where the UE 115-e-1 may report a subset of capabilities, the network and first base station 105-m-1 may be aware of the existence of non-reported groups, such as through an indication provided by the UE 115-e-1. In some examples, the UE may inform the first base station 105-m-1 of the number of groups it supports (e.g., how many groups of LTE and NR capabilities are present). In some cases, the UE 115-e-1 may provide an indication of a number of groups and a summary of what capabilities are associated with each group (e.g., one or more of: band ranges (L, M, H, L+H, M+H), category or data rate, number of carriers, etc.). The UE 115-e-1 may report a group, then flag that it has under-reported the list or that it has sampled the capability list (e.g., omitted carrier aggregation, or some band combinations). Then the first base station 105-m-1 or network may decide to use the sampled list, or query for a full list. This could apply to subsets of capability groups, or for all sets. In some cases, a mapping may be provided between capability groups and associated capabilities, and UE 115-e-1 may report an index associated with the mapping to indicate that one or more capability groups are present at the UE 115-e-1 that have not been reported.

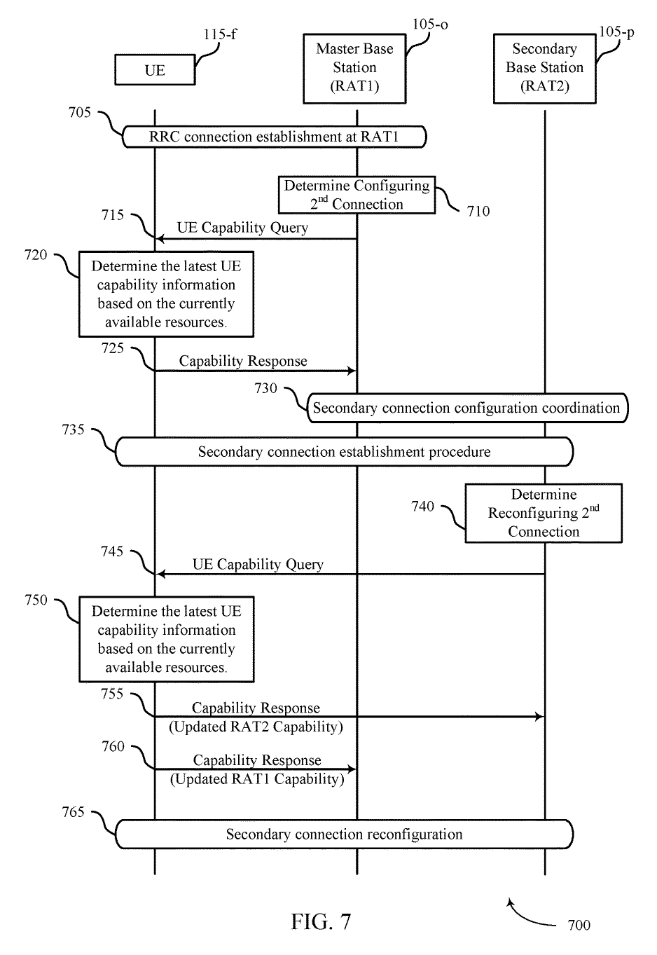

FIG. 7 illustrates an example of a process flow 700 for UE capability determination for coordination across multiple RATs. Process flow 700 may include a first or master base station 105-o that uses a first RAT, a second or secondary base station 105-p that uses a second RAT, and UE 115-f, which may be examples of the corresponding devices described with reference to FIGS. 1-6. The master base station 105-o and the UE 115-f may, at block 705, establish an RRC connection using the first RAT. The first RAT may be, for example, an LTE or 4G RAT, and the RRC connection may be established using associated RRC connection establishment procedures of the first RAT. As part of the RRC connection establishment, the UE 115-f may provide the overall UE capability information, including the capability of the UE 115-f to establish connections according to one or more different RATs and capabilities of such connections with the different RATs (e.g., bandwidth capabilities, capabilities for multiple CCs, etc.).

At block 710, the master base station 105-o may determine that a second connection should be configured. Such a determination may be made based on, for example, the master base station 105-o determining that data traffic exceeds the capacity of the established first connection. The master base station 105-o, also may make the determination based on one or more other factors, such as the ability of the UE 115-f to establish a connection using the second RAT, available resources of the first RAT that could be allocated to the UE 115-f, or combinations thereof.

The master base station 105-o may then request the UE 115-f to provide the latest UE capability information in UE capability query 715 that is transmitted to the UE 115-f The UE capability query may be, for example, a UE capability enquiry message that is transmitted in RRC signaling on a downlink control channel, and that may be received by the UE 115-f and recognized as being a UE capability enquiry message. In some examples, the master base station 105-o may transmit a general UE capability query to prompt a UE capability response that includes the entire current capabilities of the UE (e.g., RATs supported, RF resources or a number RF chains available for different RATs, etc.). In some examples, the master base station 105-o may transmit a specific UE capability query that includes additional information, such as a reconfiguration type information that indicates a type of reconfiguration the master base station 105-o is planning to do after the UE capability report is received, a type of capability information that should be reported by the UE 115-f, a network capability, or a configuration to be performed. For example, the additional information may indicate that the reconfiguration may include adding a CC to the first connection, or adding a second connection to secondary base station 105-p using the second RAT. Such a specific UE capability query, and associated response, may help reduce the amount of information transmitted between the UE 115-f and master base station 105-o, and thereby increase available resources for other types of transmissions (e.g., user data transmissions).

At block 720, the UE 115-f may determine the latest UE capability information based on the currently available resources. Such a determination may take into account, for example, the available resources (e.g. RF chains, memory) and/or the current UE status (e.g. CPU load, temperature of the device). The UE 115-f may provide the UE capability information in capability response 725 that is transmitted to the master base station 105-o. The capability response 725 may include a UE capability information message sent via RRC signaling, for example. In examples where the UE capability query 715 includes reconfiguration type information, the UE 115-f may provide the UE capability information according to the additional information in the UE capability query 715, such as capability information related to a type of capability (e.g., capability for one or more connections using the second RAT). In examples where the UE capability query 715 includes a network capability, or a configuration to be performed, the capability response 725 may include capability information that does not exceed the network capability or the configuration to be performed. The UE capability query 715 may include a UE capability enquiry message sent via RRC signaling, for example.

At block 730, the master base station 105-o and the secondary base station 105-p may coordinate the configuration for a second connection that is to be established between the secondary base station 105-p and the UE 115-f. In some examples, the master base station 105-o and the secondary base station 105-p may coordinate via a backhaul connection, and the master base station 105-o may provide one or more of a DRB configuration, flow configuration, security configuration, or UE capability information to the secondary base station 105-p for use in establishing the secondary connection.

The secondary base station 105-p, the master base station 105-o, and the UE 115-f may then reconfigure the UE 115-f with the secondary connection over the second RAT using secondary connection establishment procedure 735. The second RAT may be, for example, a 5G or NR RAT, and the secondary connection establishment procedure may include associated 5G or NR RRC connection establishment procedures of the second RAT.

The secondary base station 105-p may, at block 740, determine that the secondary connection is to be reconfigured. Such a determination may be made, for example, when the secondary base station 105-p determined that data traffic with the UE 115-f requires more bandwidth, which may be provided through an additional CC that may be established between the UE 115-f and the secondary base station 105-p.

The secondary base station 105-p may format and transmit a UE capability query 745 to the UE 115-f to determine the latest UE 115-f capability for connections using the second RAT. The UE capability query 745 may be transmitted directly to the UE 115-f from the secondary base station 105-p, or may be tunneled through the master base station 105-o. In some examples, the secondary base station 105-p may transmit a specific UE capability query that includes additional information, such as a reconfiguration type information that indicates a type of reconfiguration the secondary base station 105-o is planning to do after the UE capability report is received. For example, the additional information may indicate that the reconfiguration may include adding a CC to the secondary connection using the second RAT. In other examples, the additional information may include a network capability, or a configuration to be performed, and the associated response may include capability information that does not exceed the network capability or the configuration to be performed. Such a specific UE capability query, and associated response, may help reduce the amount of information transmitted between the UE 115-f and secondary base station 105-, and thereby increase available resources for other types of transmissions (e.g., user data transmissions).

At block 750, the UE 115-f may determine the latest UE capability information based on the currently available resources. Such a determination may take into account, for example, the available resources (e.g. RF chains, memory) and/or the current UE status (e.g. CPU load, temperature of the device). The UE 115-f may provide the UE capability information in capability response 755 that is transmitted to the secondary base station 105-p. In examples where the UE capability query 745 includes reconfiguration type information, the UE 115-f may provide the UE capability information according to the additional information in the UE capability query 745, such as capability information related to establishing a second connection or second CC using the second RAT, or capability information that does not exceed the network capability or the configuration to be performed, for example.

Additionally, the UE may send a UE capability response 760 to the master base station 105-o, which may include the latest UE capability information for connections with the first RAT, so that the master base station 105-o has the latest UE capability information for use in determine future potential reconfigurations. In some examples, the UE 115-f transmits the UE capability response 760 to the master base station 105-o only when the UE capability relative to the first RAT is changed from a last-reported UE capability. For example, if the last-reported UE capability provided to the master base station 105-o indicated that the UE 115-f had capability for three CCs using the first RAT, and the secondary connection is reconfigured to have an additional CC such that the UE 115-f can support only two CCs using the first RAT, the UE 115-f may transmit such an updated UE capability.

In some examples, the UE 115-f may autonomously send the UE capability response 760 to the master base station 105-o. In other examples, in order to prevent an unexpected UE capability transmission at the master base station 105-o, the secondary base station 105-p may notify the master base station 105-o that the secondary base station 105-p is going to reconfigure or has already reconfigured the secondary connection (e.g., via a backhaul Xn interface), and the master base station 105-o may transmit a UE capability query to the UE 115-f that requests the UE 115-f to report the latest UE capability information. Such a coordination may occur either before or after secondary connection reconfiguration 765.

According to such techniques, UE 115-f resources may be configured to provide resources to different RATs under network control, but with relatively little information required to be exchanged between the master base station 105-p and the secondary base station 105-p. Thus, overhead related to coordination between base stations of different RANs may be efficient and each base station may configure connections based on a latest UE capability associated with the particular RAT. Such techniques may also help to prevent ping-pong reconfigurations of UE 115-f, through the coordination of secondary connections through the master base station 105-o.

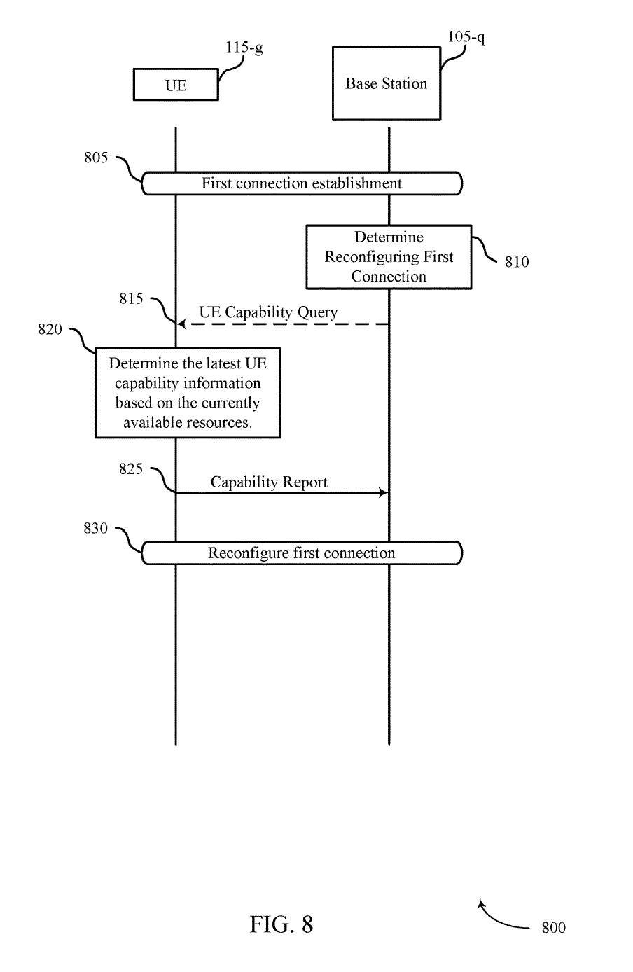

FIG. 8 illustrates an example of a process flow 800 for UE capability determination for a single-RAT connection, in accordance with aspects of the disclosure. Process flow 800 may include a base station 105-q that uses a first RAT (e.g., an LTE or 4G RAT, a 5G or NR RAT, or any other type of RAT), and UE 115-g, which may be examples of the corresponding devices described with reference to FIGS. 1-6. The station 105-q and the UE 115-g may, at block 805, establish a first connection using the first RAT. For example, the first RAT may be a LTE or 4G RAT, and the first connection may be established using associated RRC connection establishment procedures of the first RAT. As part of the RRC connection establishment, the UE 115-g may provide the overall UE capability information, including the capability of the UE 115-g to establish one or more connections at the first RAT and capabilities of such connections (e.g., bandwidth capabilities, capabilities for multiple CCs, etc.).

At block 810, the base station 105-q may determine that the first connection should be reconfigured. Such a determination may be made based on, for example, the base station 105-q determining that data traffic exceeds the capacity of the established first connection. The base station 105-q, also may make the determination based on one or more other factors, such as the ability of the UE 115-g to reconfigure the connection, available resources of the first RAT that could be allocated to the UE 115-g, or combinations thereof.

The base station 105-q may, in some cases, then request the UE 115-g to provide the latest UE capability information in UE capability query 815 that is transmitted to the UE 115-g. The UE capability query may be a UE capability enquiry message that is transmitted in RRC signaling on a downlink control channel, and that may be received by the UE 115-g and recognized as being a UE capability enquiry message.

At block 820, the UE 115-g may determine the latest UE capability information based on the currently available resources. Such a determination may take into account, for example, the available resources (e.g. RF chains, memory) and/or the current UE status (e.g. CPU load, temperature of the device). The UE 115-g may provide the UE capability information in capability report 825 that is transmitted to the base station 105-q. The capability report 825 may include a UE capability information message sent via RRC signaling, for example. At block 830, the base station 105-q and the UE 115-g may reconfigure the first connection in accordance with the most recent UE capabilities.

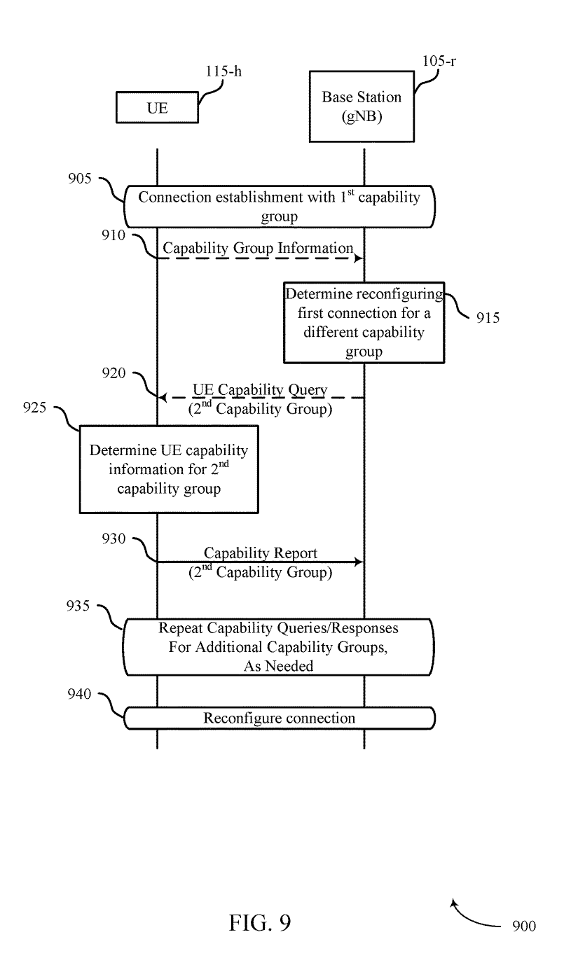

FIG. 9 illustrates an example of a process flow 900 for UE capability determination for a single-RAT connection, in accordance with aspects of the disclosure. Process flow 900 may include a base station 105-r that uses a first RAT (e.g., an LTE or 4G RAT, a 5G or NR RAT, or any other type of RAT), and UE 115-h, which may be examples of the corresponding devices described with reference to FIGS. 1-6. The station 105-r and the UE 115-h may, at block 905, establish a first connection using a first capability group at the first RAT. The first capability group may be, for example, a subset of available capabilities at the UE 115-h. For example, the first RAT may be a LTE or 4G RAT, a 5G or NR RAT, or any other type of RAT, and the first connection may be established using associated RRC connection establishment procedures of the first RAT. As part of the RRC connection establishment, the UE 115-h may provide the overall UE capability information, or the UE 115-h may provide capability group information 910 in an indication separate from the RRC establishment. The capability group information may provide an indication of a number of capability groups at the UE 115-h, an indication of what the capability groups are (e.g., bandwidth capabilities, capabilities for multiple CCs, etc.), or combinations thereof.

At block 915, the base station 105-r may determine that the first connection should be reconfigured for a different capability group. Such a determination may be made based on, for example, the base station 105-r determining that data traffic exceeds the capacity of the established first connection. The base station 105-r, also may make the determination based on one or more other factors, such as the ability of the UE 115-h to reconfigure the connection, available resources of the first RAT that could be allocated to the UE 115-h, or combinations thereof.

The base station 105-r, in some cases, may then request the UE 115-h to provide UE capability information for a second capability group (or one or more other capability groups) in UE capability query 920 that is transmitted to the UE 115-h. The UE capability query may be a UE capability enquiry message that is transmitted in RRC signaling on a downlink control channel, and that may be received by the UE 115-h and recognized as being a UE capability enquiry message.

At block 925, the UE 115-h may determine the UE capability information for the second capability group, based on the currently available resources. Such a determination may take into account, for example, the available resources (e.g. RF chains, memory) and/or the current UE status (e.g. CPU load, temperature of the device). The UE 115-h may provide the UE capability information in capability report 930 that is transmitted to the base station 105-r. The capability report 930 may include a UE capability information message sent via RRC signaling, for example. At block 935, the base station 105-r and the UE 115-h may repeat capability queries/responses for additional capability groups, as needed. At block 940, the base station 105-r and the UE 115-h may reconfigure the first connection in accordance with the one or more of the UE capabilities reported in one or more of the UE capability groups.

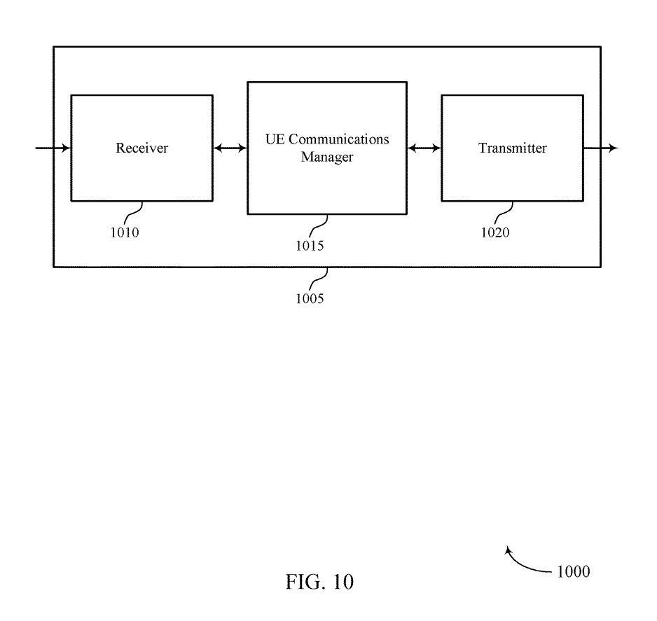

FIG. 10 shows a block diagram 1000 of a device 1005 that supports UE capability determination for coordination across multiple RATs in accordance with various aspects of the present disclosure. Device 1005 may be an example of aspects of a UE 115 as described with reference to FIGS. 1-7. Device 1005 may include receiver 1010, UE communications manager 1015, and transmitter 1020. Device 1005 may also include a processor. Each of these components may be in communication with one another (e.g., via one or more buses).

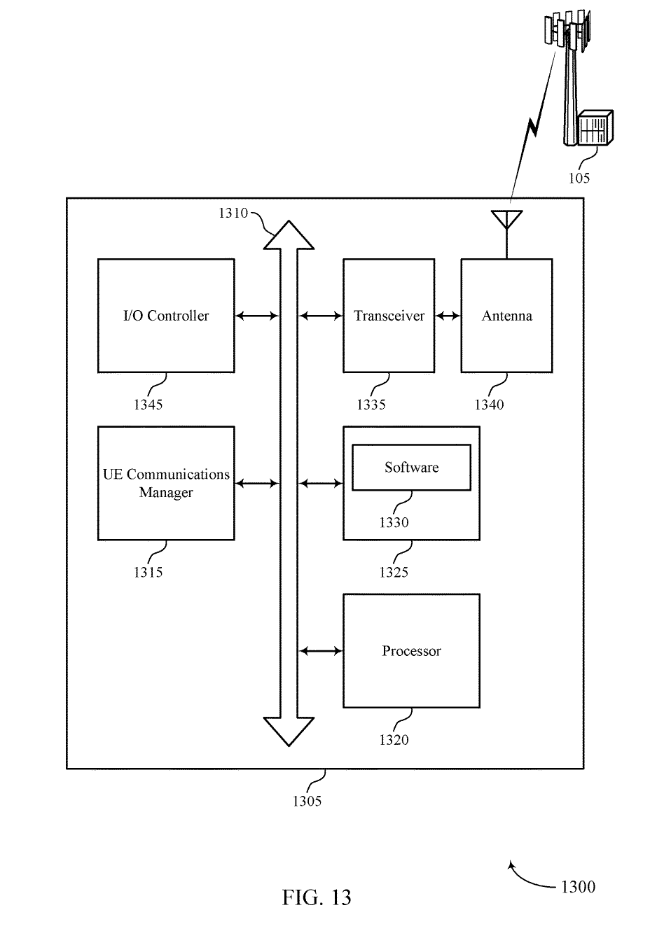

Receiver 1010 may receive information such as packets, user data, or control information associated with various information channels (e.g., control channels, data channels, and information related to UE capability determination for coordination across multiple RATs, etc.). Information may be passed on to other components of the device. The receiver 1010 may be an example of aspects of the transceiver 1335 described with reference to FIG. 13.

UE communications manager 1015 may be an example of aspects of the UE communications manager 1315 described with reference to FIG. 13, an example of aspects of the UE communication manager 102 of FIG. 1, or an example of aspects of the UE communication manager 202 of FIG. 2.

UE communications manager 1015 may establish a first connection with a first base station using a first RAT, receive a capability query for available resources for a reconfiguration procedure, and determine a UE capability based on the first connection with the first base station.

In some examples, UE communications manager 1015 may establish a connection with a base station based on a first group of capabilities of the UE, the first group of capabilities being a subset of a full set of capabilities of the UE, receive a capability query from the base station for a second group of capabilities, identify the second group of capabilities of the UE in response to the capability query, the second group of capabilities of the UE being different from the first group of capabilities of the UE, and transmit the second group of capabilities to the base station.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1335 described with reference to FIG. 13. The transmitter 1020 may include a single antenna, or it may include a set of antennas.

Transmitter 1020 may transmit the UE capability to the first base station and in some cases transmit a second UE capability responsive to a second UE capability query. In some cases, the second UE capability is transmitted to the first base station, and is used for coordination with a second base station to reconfigure one or more connections a the UE. In some cases, the second UE capability is tunneled to the second base station via the first base station. In some cases, the second UE capability is transmitted directly to the second base station.

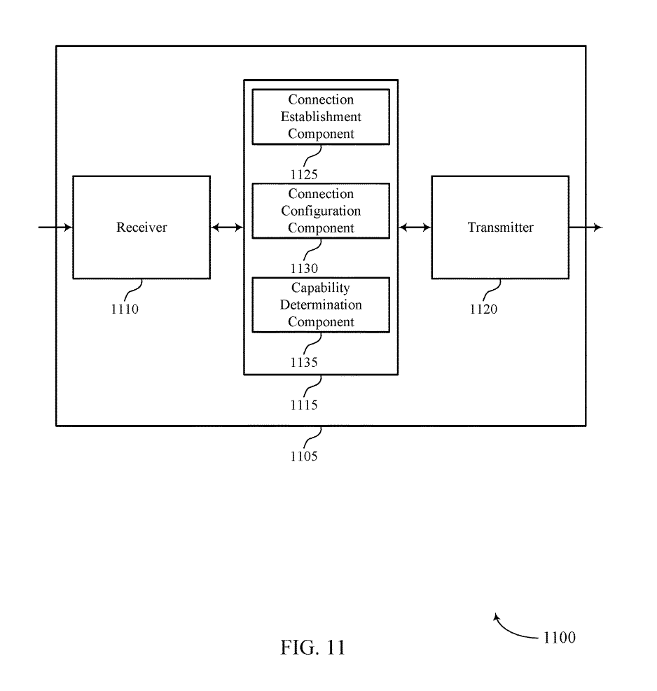

FIG. 11 shows a block diagram 1100 of a device 1105 that supports UE capability determination for coordination across multiple RATs in accordance with various aspects of the present disclosure. Device 1105 may be an example of aspects of a device 1005 or a UE 115 as described with reference to FIGS. 1-10. Device 1105 may include receiver 1110, UE communications manager 1115, and transmitter 1120. Device 1105 may also include a processor. Each of these components may be in communication with one another (e.g., via one or more buses).

Receiver 1110 may receive information such as packets, user data, or control information associated with various information channels (e.g., control channels, data channels, and information related to UE capability determination for coordination across multiple RATs, etc.). Information may be passed on to other components of the device. The receiver 1110 may be an example of aspects of the transceiver 1335 described with reference to FIG. 13.

UE communications manager 1115 may be an example of aspects of the UE communications manager 1315 described with reference to FIG. 13, an example of aspects of the UE communication manager 102 of FIG. 1, or an example of aspects of the UE communication manager 202 of FIG. 2.

UE communications manager 1115 may also include connection establishment component 1125, connection configuration component 1130, and capability determination component 1135.

Connection establishment component 1125 may establish a first connection with a first base station using a first RAT and establish a second connection with the second base station using the second RAT. In some examples, connection establishment component 1125 may establish a connection with a base station based on a first group of capabilities of the UE, the first group of capabilities being a subset of a full set of capabilities of the UE.

Connection configuration component 1130 may receive a capability query for available resources for a reconfiguration procedure from a first or a second base station, and coordinate a UE capability response. In some cases, the connection configuration component 1130 may reconfigure one or more of a first connection with a first base station, or a second connection with the second base station according to a reconfiguration procedure. In some cases, the reconfiguration procedure includes one or more of an establishment of a second connection with the second base station using the second RAT, an establishment of another connection with the first base station using the first RAT, or a reconfiguration of the first connection with the first base station using the first RAT. In some cases, a second capability query from the second base station is received via the first base station using the first RAT. In some cases, the reconfiguration procedure includes at least one parameter change to any connection which has already been established between the UE and a radio access network. In some cases, the capability query includes an indication of a type of a reconfiguration to be processed, or includes a query of a specific UE capability related to a specific configuration indicated in the capability query.

In some examples, connection configuration component 1130 may transmit information on a first group of capabilities, and a second group of capabilities to the base station, receive a connection reconfiguration message from the base station based on the second group of capabilities, and reconfigure the connection with the base station to enable one or more capabilities of the second group of capabilities.

Capability determination component 1135 may determine a UE capability based on the first connection with the first base station, or based on the first connection and the second connection (and/or one or more other connections), and transmit the UE capability to one or more of the first base station or second base station. In some cases, a modified UE capability may be transmitted to the first base station responsive to a later capability query received from the first base station or the second base station. In some cases, the UE capability includes capabilities relevant to the type of reconfiguration given by the capability query or a specific configuration indicated in the capability query.

In some cases, capability determination component 1135 may provide an indication to the base station that a first group of capabilities of the UE is a subset of the full set of capabilities of the UE, receive a capability query from the base station for a second group of capabilities, and identify the second group of capabilities of the UE in response to the capability query, the second group of capabilities of the UE being different from the first group of capabilities of the UE. In some cases, the indication provides a number of capability groups that the UE can support and/or an indication of a type of capabilities of each capability group other than the first group of capabilities. In some cases, the full set of capabilities of the UE include a set of capability groups including one or more of UE capabilities per frequency band for a set of frequency bands, UE capabilities per data rate for a set of data rates, UE capabilities for one or more component carriers, or any combination thereof. In some cases, the full set of capabilities of the UE further include one or more of a capability to semi-statically change one or more of the set of capability groups or a capability to dynamically change one or more of the set of capability groups.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1335 described with reference to FIG. 13. The transmitter 1120 may include a single antenna, or it may include a set of antennas.

FIG. 12 shows a block diagram 1200 of a UE communications manager 1215 that supports UE capability determination for coordination across multiple RATs in accordance with various aspects of the present disclosure. The UE communications manager 1215 may be an example of aspects of a UE communications manager 102, a UE communication manager 202, a UE communications manager 1015, a UE communications manager 1115, or a UE communications manager 1315 described with reference to FIGS. 1, 2, 10, 11, and 13. The UE communications manager 1215 may include connection establishment component 1220, connection configuration component 1225, capability determination component 1230, and UE resource determination component 1235. Each of these modules may communicate, directly or indirectly, with one another (e.g., via one or more buses).

Connection establishment component 1220 may establish a first connection with a first base station using a first RAT and establish the second connection with the second base station using the second RAT.

Connection configuration component 1225 may receive a capability query for available resources for a reconfiguration procedure from a first or a second base station, and coordinate a UE capability response. In some cases, the connection configuration component 1225 may reconfigure one or more of a first connection with a first base station, or a second connection with the second base station according to a reconfiguration procedure. In some cases, the reconfiguration procedure includes one or more of an establishment of a second connection with the second base station using the second RAT, an establishment of another connection with the first base station using the first RAT, or a reconfiguration of the first connection with the first base station using the first RAT. In some cases, a second capability query from the second base station is received via the first base station using the first RAT. In some cases, the reconfiguration procedure includes at least one parameter change to any connection which has already been established between the UE and a radio access network. In some cases, the capability query includes an indication of a type of a reconfiguration to be processed, or includes a query of a specific UE capability related to a specific configuration indicated in the capability query.

Capability determination component 1230 may determine a UE capability based on the first connection with the first base station, or based on the first connection and the second connection (and/or one or more other connections), and transmit the UE capability to one or more of the first base station or second base station. In some cases, a modified UE capability may be transmitted to the first base station responsive to a later capability query received from the first base station or the second base station. In some cases, the UE capability includes capabilities relevant to the type of reconfiguration given by the capability query or a specific configuration indicated in the capability query.

UE resource determination component 1235 may determine available UE resources based on a connected mode configuration of the UE across at least the first RAT and the second RAT.

FIG. 13 shows a diagram of a system 1300 including a device 1305 that supports UE capability determination for coordination across multiple RATs in accordance with various aspects of the present disclosure. Device 1305 may be an example of or include the components of device 1005, device 1105, or a UE 115 as described above, e.g., with reference to FIGS. 1-11. Device 1305 may include components for bi-directional voice and data communications including components for transmitting and receiving communications, including UE communications manager 1315, processor 1320, memory 1325, software 1330, transceiver 1335, antenna 1340, and I/O controller 1345. These components may be in electronic communication via one or more busses (e.g., bus 1310). Device 1305 may communicate wirelessly with one or more base stations 105.

Processor 1320 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting UE capability determination for coordination across multiple RATs).

Memory 1325 may include random access memory (RAM) and read only memory (ROM). The memory 1325 may store computer-readable, computer-executable software 1330 including instructions that, when executed, cause the processor to perform various functions described herein. In some cases, the memory 1325 may contain, among other things, a basic input/output system (BIOS) which may control basic hardware and/or software operation such as the interaction with peripheral components or devices.

Software 1330 may include code to implement aspects of the present disclosure, including code to support UE capability determination for coordination across multiple RATs. Software 1330 may be stored in a non-transitory computer-readable medium such as system memory or other memory. In some cases, the software 1330 may not be directly executable by the processor but may cause a computer (e.g., when compiled and executed) to perform functions described herein.

Transceiver 1335 may communicate bi-directionally, via one or more antennas, wired, or wireless links as described above. For example, the transceiver 1335 may represent a wireless transceiver and may communicate bi-directionally with another wireless transceiver. The transceiver 1335 may also include a modem to modulate the packets and provide the modulated packets to the antennas for transmission, and to demodulate packets received from the antennas.

In some cases, the wireless device may include a single antenna 1340. However, in some cases the device may have more than one antenna 1340, which may be capable of concurrently transmitting or receiving multiple wireless transmissions.

I/O controller 1345 may manage input and output signals for device 1305. I/0 controller 1345 may also manage peripherals not integrated into device 1305. In some cases, I/O controller 1345 may represent a physical connection or port to an external peripheral. In some cases, I/O controller 1345 may utilize an operating system such as iOS®, ANDROID®, MS-DOS®, MS-WINDOWS®, OS/2®, UNIX®, LINUX®, or another known operating system.

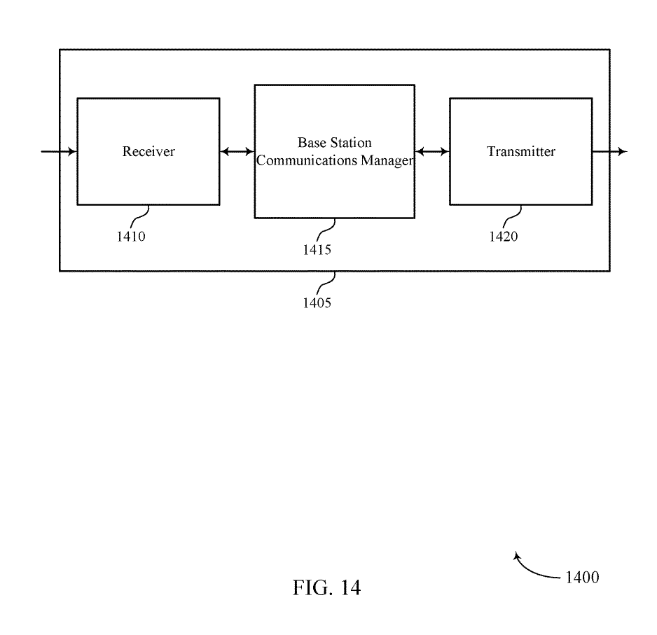

FIG. 14 shows a block diagram 1400 of a device 1405 that supports UE capability determination for coordination across multiple RATs in accordance with various aspects of the present disclosure. Device 1405 may be an example of aspects of a base station 105, a first base station 105-e, a first base station 105-g, a first base station 105-i, a first base station 105-k, a first base station 105-m, or a master base station 105-o as described with reference to FIGS. 1-7. Device 1405 may include receiver 1410, base station communications manager 1415, and transmitter 1420. Device 1405 may also include a processor. Each of these components may be in communication with one another (e.g., via one or more buses).

Receiver 1410 may receive information such as packets, user data, or control information associated with various information channels (e.g., control channels, data channels, and information related to UE capability determination for coordination across multiple RATs, etc.). Information may be passed on to other components of the device. The receiver 1410 may be an example of aspects of the transceiver 2035 described with reference to FIG. 20.

Base station communications manager 1415 may be an example of aspects of the RAT1 network communication manager 101 described with reference to FIG. 1, the RAT1 network communication manager 201 described with reference to FIG. 2, or base station communications manager 2015 described with reference to FIG. 20.

Base station communications manager 1415 may establish a connection with a UE using the first RAT, determine that the connection with the UE is to be reconfigured, transmit a capability query to the UE that queries for available resources for the reconfiguration, receive a UE capability response from the UE, and initiate the reconfiguration of the connection with the UE.

In some cases, base station communications manager 1415 may establish a connection with a UE based on a first group of capabilities of the UE, transmit a capability query to the UE for a second group of capabilities, and receive, from the UE, an indication of the second group of capabilities UE, the second group of capabilities being different from the first group of capabilities of the UE.

Transmitter 1420 may transmit signals generated by other components of the device. In some examples, the transmitter 1420 may be collocated with a receiver 1410 in a transceiver module. For example, the transmitter 1420 may be an example of aspects of the transceiver 2035 described with reference to FIG. 20. The transmitter 1420 may include a single antenna, or it may include a set of antennas.

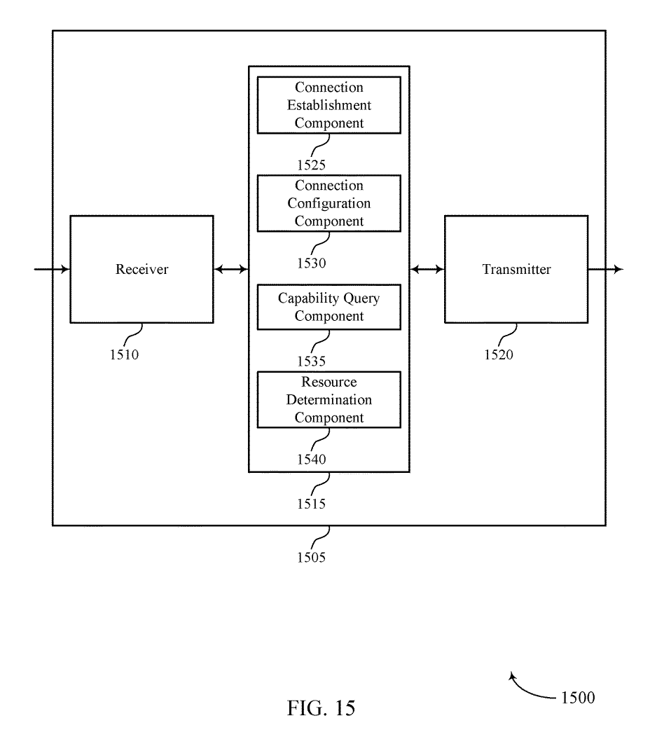

FIG. 15 shows a block diagram 1500 of a device 1515 that supports UE capability determination for coordination across multiple RATs in accordance with various aspects of the present disclosure. Device 1515 may be an example of aspects of a device 1405, a base station 105, a first base station 105-e, a first base station 105-g, a first base station 105-i, a first base station 105-k, a first base station 105-m, or a master base station 105-o as described with reference to FIGS. 1-7 and 12. Device 1515 may include receiver 1510, base station communications manager 1515, and transmitter 1520. Device 1505 may also include a processor. Each of these components may be in communication with one another (e.g., via one or more buses).

Receiver 1510 may receive information such as packets, user data, or control information associated with various information channels (e.g., control channels, data channels, and information related to UE capability determination for coordination across multiple RATs, etc.). Information may be passed on to other components of the device. The receiver 1510 may be an example of aspects of the transceiver 2035 described with reference to FIG. 20.

Base station communications manager 1515 may be an example of aspects of the RAT1 network communication manager 101 described with reference to FIG. 1, the RAT1 network communication manager 201 described with reference to FIG. 2, or base station communications manager 2015 described with reference to FIG. 20.

Base station communications manager 1515 may also include connection establishment component 1525, connection configuration component 1530, capability query component 1535, and resource determination component 1540.

Connection establishment component 1525 may establish a connection with a UE using the first RAT. Connection configuration component 1530 may determine that the connection with the UE is to be reconfigured and initiate the reconfiguration of the connection with the UE. In some cases, the determining that the connection with the UE is to be reconfigured includes determining that the connection using the first RAT is to be reconfigured.

Capability query component 1535 may transmit a capability query to the UE that queries for available resources for the reconfiguration and transmit a second capability query to the UE. Resource determination component 1540 may receive a UE capability response or modified capability response from the UE that indicates UE capability for connections using the first RAT. In some cases, the determining that the connection with the UE is to be reconfigured includes determining that a second connection with a second base station using a second RAT is to be established. In some cases, the determining that the second connection with the second base station is to be established includes determining that data traffic between the first base station and the UE exceeds available capacity of the first base station. In some cases, the modified UE capability is received responsive to the second capability query.

In some cases, capability query component 1535 may receive an indication from the UE that the first group of capabilities are less than the full set of capabilities of the UE, transmit a capability query to the UE for a second group of capabilities, and receive from the UE an indication of the second group of capabilities UE. The second group of capabilities may be different from the first group of capabilities of the UE. In some cases, the indication provides a number of capability groups that the UE can support and/or an indication of a type of capabilities of each capability group other than the first group of capabilities. In some cases, the full set of capabilities of the UE include a set of capability groups including one or more of UE capabilities per frequency band for a set of frequency bands, UE capabilities per data rate for a set of data rates, UE capabilities for one or more component carriers, or any combination thereof. In some cases, the full set of capabilities of the UE further include one or more of a capability to semi-statically change one or more of the set of capability groups or a capability to dynamically change one or more of the set of capability groups.

Transmitter 1520 may transmit signals generated by other components of the device. In some examples, the transmitter 1520 may be collocated with a receiver 1510 in a transceiver module. For example, the transmitter 1520 may be an example of aspects of the transceiver 2035 described with reference to FIG. 20. The transmitter 1520 may include a single antenna, or it may include a set of antennas.

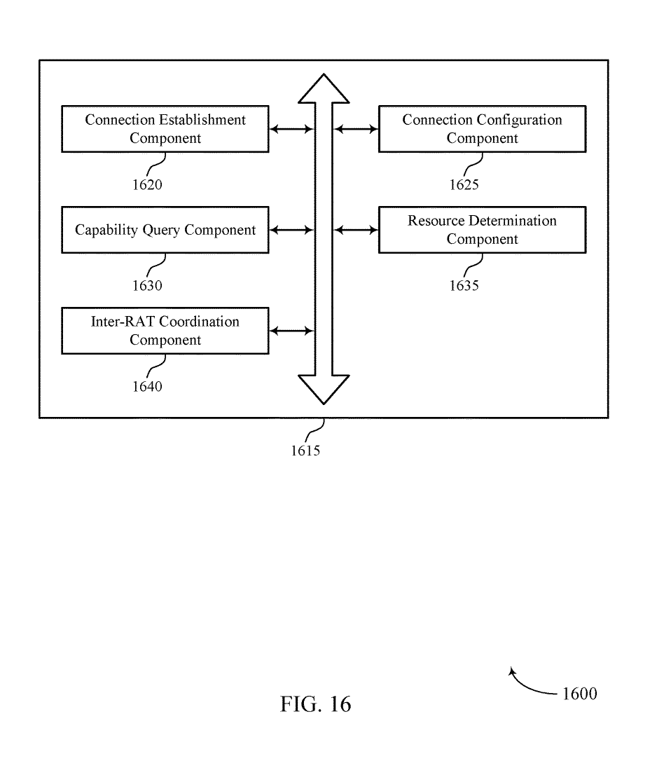

FIG. 16 shows a block diagram 1600 of a base station communications manager 1615 that supports UE capability determination for coordination across multiple RATs in accordance with various aspects of the present disclosure. The base station communications manager 1615 may be an example of aspects of the RAT1 network communication manager 101 described with reference to FIG. 1, the RAT1 network communication manager 201 described with reference to FIG. 2, the base station communications manager 1415, the base station communications manager 1515, or the base station communications manager 2015 described with reference to FIGS. 1, 2, 14, 15, and 20. The base station communications manager 1615 may include connection establishment component 1620, connection configuration component 1625, capability query component 1630, resource determination component 1635, and inter-RAT coordination component 1640. Each of these modules may communicate, directly or indirectly, with one another (e.g., via one or more buses).

Connection establishment component 1620 may establish a connection with a UE using the first RAT. Connection configuration component 1625 may determine that the connection with the UE is to be reconfigured and initiate the reconfiguration of the connection with the UE. In some cases, the determining that the connection with the UE is to be reconfigured includes determining that the connection using the first RAT is to be reconfigured.

Capability query component 1630 may transmit a capability query to the UE that queries for available resources for the reconfiguration and in some cases may transmit a second capability query to the UE. Resource determination component 1635 may receive a UE capability response from the UE that indicates UE capability for connections using the first RAT. In some cases, the determining that the connection with the UE is to be reconfigured includes determining that a second connection with a second base station using a second RAT is to be established. In some cases, the determining that the second connection with the second base station is to be established includes determining that data traffic between the first base station and the UE exceeds available capacity of the first base station. In some cases, a modified UE capability is received responsive to a second capability query.

Inter-RAT coordination component 1640 may coordinate with a second base station to establish a second connection at the UE, and in some cases may receive a notification from the second base station of a reconfiguration of the connection with the second base station. In some cases, the initiating the reconfiguration of the connection with the UE includes coordinating with the second base station to configure the second connection using the second RAT. In some cases, the coordinating includes providing the UE capability response corresponding to the second RAT to the second base station, and providing one or more of a DRB configuration, a flow configuration, or a security configuration for the connection with the second base station.

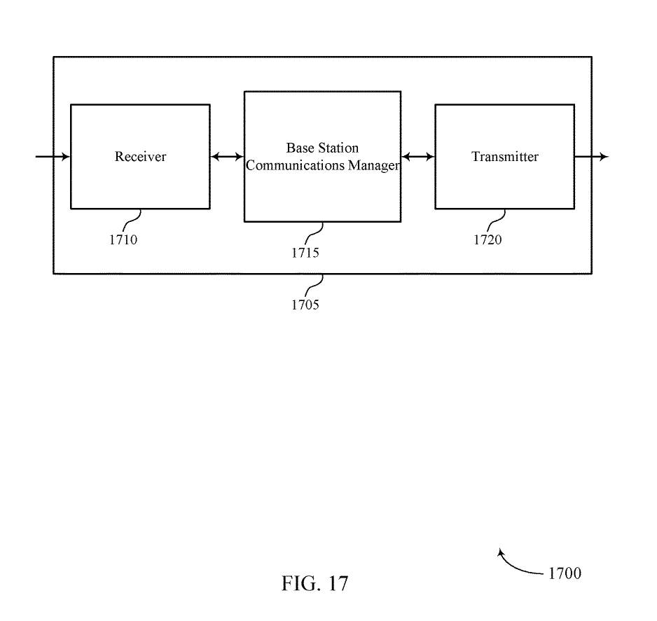

FIG. 17 shows a block diagram 1700 of a device 1705 that supports UE capability determination for coordination across multiple RATs in accordance with various aspects of the present disclosure. Device 1705 may be an example of aspects of a base station 105, a second base station 105-f, a second base station 105-h, a second base station 105-j, a second base station 105-1, a second base station 105-n, a secondary base station 105-p, or a base station 105-q as described with reference to FIGS. 1-8. Device 1705 may include receiver 1710, communications manager 1715, and transmitter 1720. Device 1705 may also include a processor. Each of these components may be in communication with one another (e.g., via one or more buses).

Receiver 1710 may receive information such as packets, user data, or control information associated with various information channels (e.g., control channels, data channels, and information related to UE capability determination for coordination across multiple RATs, etc.). Information may be passed on to other components of the device. The receiver 1710 may be an example of aspects of the transceiver 2035 described with reference to FIG. 20.

Communications manager 1715 may be an example of aspects of the RAT2 network communication manager 103 described with reference to FIG. 1, the RAT1 network communication manager 203 described with reference to FIG. 2, or base station communications manager 2015 described with reference to FIG. 20.

Communications manager 1715 may coordinate with a first base station that has an established connection with a UE using a first RAT to establish a second connection using the second RAT, establish the second connection with the UE using the second RAT, determine that the second connection using the second RAT is to be reconfigured, transmit a capability query to the UE to determine UE resources for the reconfigured connection, receive a capability query response from the UE, and reconfigure the connection using the second RAT based on the capability query response.

Transmitter 1720 may transmit signals generated by other components of the device. In some examples, the transmitter 1720 may be collocated with a receiver 1710 in a transceiver module. For example, the transmitter 1720 may be an example of aspects of the transceiver 2035 described with reference to FIG. 20. The transmitter 1720 may include a single antenna, or it may include a set of antennas.

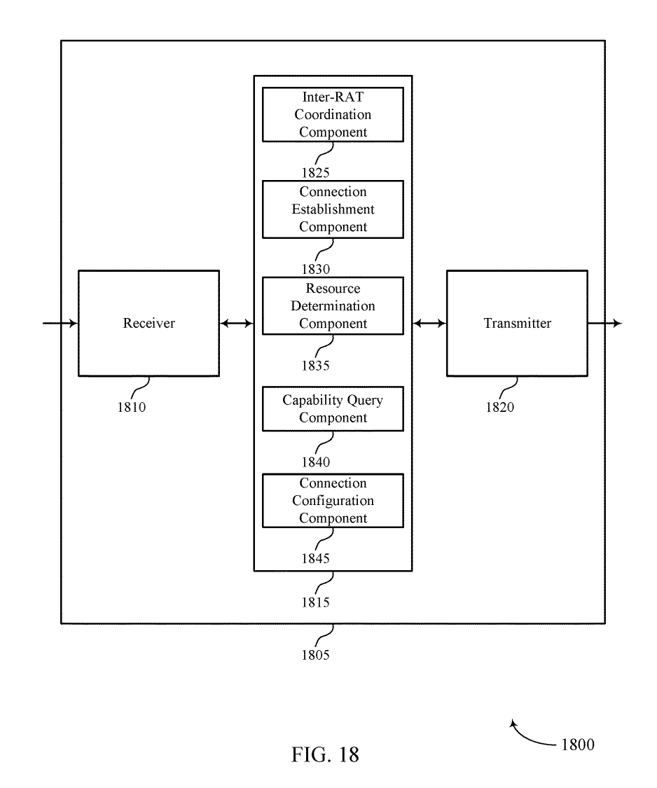

FIG. 18 shows a block diagram 1800 of a device 1805 that supports UE capability determination for coordination across multiple RATs in accordance with various aspects of the present disclosure. Device 1805 may be an example of aspects of a base station 105, a second base station 105-f, a second base station 105-h, a second base station 105-j, a second base station 105-1, a second base station 105-n, a secondary base station 105-p, a device 1705, or a device 2005 as described with reference to FIGS. 1-7, 17 and 20. Device 1805 may include receiver 1810, communications manager 1815, and transmitter 1820. Device 1805 may also include a processor. Each of these components may be in communication with one another (e.g., via one or more buses).

Receiver 1810 may receive information such as packets, user data, or control information associated with various information channels (e.g., control channels, data channels, and information related to UE capability determination for coordination across multiple RATs, etc.). Information may be passed on to other components of the device. The receiver 1810 may be an example of aspects of the transceiver 2035 described with reference to FIG. 20.

Communications manager 1815 may be an example of aspects of the RAT2 network communication manager 103 described with reference to FIG. 1, the RAT1 network communication manager 203 described with reference to FIG. 2, or aspects of the base station communications manager 2015 described with reference to FIG. 20.

Communications manager 1815 may also include inter-RAT coordination component 1825, connection establishment component 1830, resource determination component 1835, capability query component 1840, and connection configuration component 1845.

Inter-RAT coordination component 1825 may coordinate with a first base station that has an established connection with a UE using the first RAT to establish a connection using a second RAT and in some cases may notify the first base station of a reconfiguration of the connection. In some cases, a capability query may be transmitted to a UE by tunneling the capability query to the UE through the connection with the first base station.

Connection establishment component 1830 may establish the connection with the UE using the second RAT. Resource determination component 1835 may determine that the connection using the second RAT is to be reconfigured and receive a capability query response from the UE.

Capability query component 1840 may transmit a capability query to the UE to determine UE resources for the reconfigured connection. Connection configuration component 1845 may reconfigure the connection using the second RAT based on the capability query response.

Transmitter 1820 may transmit signals generated by other components of the device. In some examples, the transmitter 1820 may be collocated with a receiver 1810 in a transceiver module. For example, the transmitter 1820 may be an example of aspects of the transceiver 2035 described with reference to FIG. 20. The transmitter 1820 may include a single antenna, or it may include a set of antennas.

FIG. 19 shows a block diagram 1900 of a base station communications manager 1915 that supports UE capability determination for coordination across multiple RATs in accordance with various aspects of the present disclosure. The base station communications manager 1915 may be an example of aspects of the RAT2 network communication manager 103 described with reference to FIG. 1, the RAT1 network communication manager 203 described with reference to FIG. 2, the base station communications manager 1715, the communications manager 1815, or a base station communications manager 2015 described with reference to FIGS. 1, 2, 17, 18, and 20. The base station communications manager 1915 may include inter-RAT coordination component 1920, connection establishment component 1925, resource determination component 1930, capability query component 1935, connection configuration component 1940, capability identification component 1945, and capability determination component 1950. Each of these modules may communicate, directly or indirectly, with one another (e.g., via one or more buses).

Inter-RAT coordination component 1920 may coordinate with a first base station that has an established connection with a UE using the first RAT to establish a connection with the second base station using the second RAT and in some cases may notify the first base station of a reconfiguration of the connection with the second base station. In some cases, a capability query may be transmitted by tunneling the capability query to the UE through the connection with the first base station.

Connection establishment component 1925 may establish the connection with the UE using the second RAT. Resource determination component 1930 may determine that the connection using the second RAT is to be reconfigured and receive a capability query response from the UE.

Capability query component 1935 may transmit a capability query to the UE to determine UE resources for the reconfigured connection. Connection configuration component 1940 may reconfigure the connection using the second RAT based on the capability query response.

Capability identification component 1945 may provide an indication in a capability query of a type of a reconfiguration to be processed by the second base station for the reconfigured connection. In some cases, the capability query includes a query of a specific UE capability related to a specific configuration.

Capability determination component 1950 may identify information in a capability query response that includes UE capabilities relevant to the type of reconfiguration given by the capability query. In some cases, the UE capability response includes UE capabilities relevant to the specific configuration indicated in the capability query.

FIG. 20 shows a diagram of a system 2000 including a device 2005 that supports UE capability determination for coordination across multiple RATs in accordance with various aspects of the present disclosure. Device 2005 may be an example of or include the components of base stations 105 as described above, e.g., with reference to FIGS. 1-7. Device 2005 may include components for bi-directional voice and data communications including components for transmitting and receiving communications, including base station communications manager 2015, processor 2020, memory 2025, software 2030, transceiver 2035, antenna 2040, network communications manager 2045, and base station coordination manager 2050. These components may be in electronic communication via one or more busses (e.g., bus 2010). Device 2005 may communicate wirelessly with one or more UEs 115.

Base station communications manager 2015 may manage communications with UE 115 and other base station 105, and may include a controller or scheduler for controlling communications with UEs 115 in cooperation with other base stations 105. Base station communications manager 2015 may perform operations associated with a device 1315, device 1415, device 1515, device 1615, device 1715, or device 1815 of FIGS. 13-18. The base station coordination manager 2050 may coordinate connection establishment and scheduling for transmissions to UEs 115 for different RATs. In some examples, base station coordination manager 2050 may provide an Xn interface within wireless communication network to provide communication between base stations 105.

Processor 2020 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 2020 may be configured to operate a memory array using a memory controller. In other cases, a memory controller may be integrated into processor 2020. Processor 2020 may be configured to execute computer-readable instructions stored in a memory to perform various functions (e.g., functions or tasks supporting UE capability determination for coordination across multiple RATs).

Memory 2025 may include RAM and ROM. The memory 2025 may store computer-readable, computer-executable software 2030 including instructions that, when executed, cause the processor to perform various functions described herein. In some cases, the memory 2025 may contain, among other things, a BIOS which may control basic hardware and/or software operation such as the interaction with peripheral components or devices.

Software 2030 may include code to implement aspects of the present disclosure, including code to support UE capability determination for coordination across multiple RATs. Software 2030 may be stored in a non-transitory computer-readable medium such as system memory or other memory. In some cases, the software 2030 may not be directly executable by the processor but may cause a computer (e.g., when compiled and executed) to perform functions described herein.

Transceiver 2035 may communicate bi-directionally, via one or more antennas, wired, or wireless links as described above. For example, the transceiver 2035 may represent a wireless transceiver and may communicate bi-directionally with another wireless transceiver. The transceiver 2035 may also include a modem to modulate the packets and provide the modulated packets to the antennas for transmission, and to demodulate packets received from the antennas.

In some cases, the wireless device may include a single antenna 2040. However, in some cases the device may have more than one antenna 2040, which may be capable of concurrently transmitting or receiving multiple wireless transmissions.

Network communications manager 2045 may manage communications with the core network (e.g., via one or more wired backhaul links). For example, the network communications manager 2045 may manage the transfer of data communications for client devices, such as one or more UEs 115.

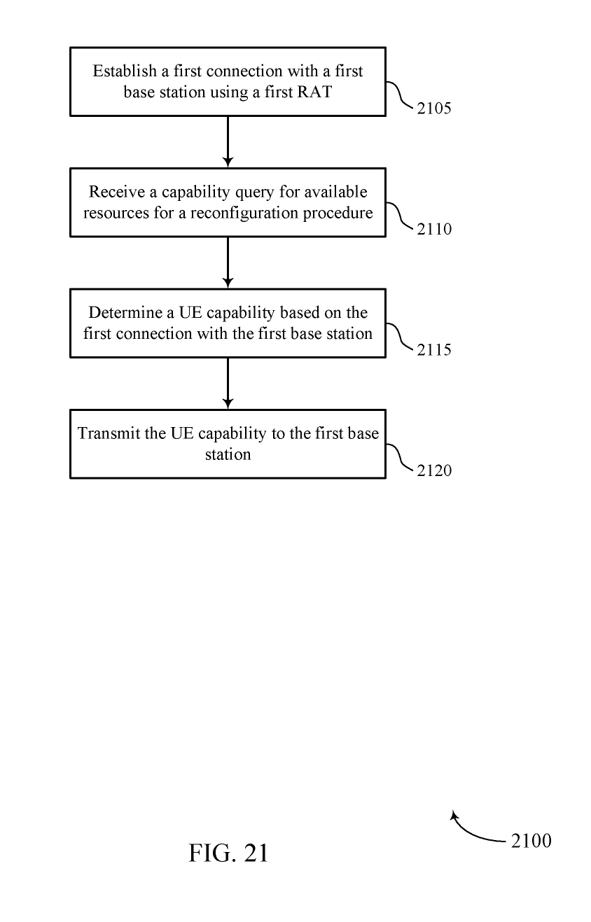

FIG. 21 shows a flowchart illustrating a method 2100 for UE capability determination for coordination across multiple RATs in accordance with various aspects of the present disclosure. The operations of method 2100 may be implemented by a UE 115 or its components as described herein. For example, the operations of method 2100 may be performed by a UE communications manager as described with reference to FIGS. 10 through 13. In some examples, a UE 115 may execute a set of codes to control the functional elements of the device to perform the functions described below. Additionally or alternatively, the UE 115 may perform aspects the functions described below using special-purpose hardware.

At block 2105 the UE 115 may establish a first connection with a first base station using a first RAT. The operations of block 2105 may be performed according to the methods described with reference to FIGS. 1 through 9. In certain examples, aspects of the operations of block 2105 may be performed by a connection establishment component as described with reference to FIGS. 10 through 13.

At block 2110 the UE 115 may receive a capability query for available resources for a reconfiguration procedure. The operations of block 2110 may be performed according to the methods described with reference to FIGS. 1 through 9. In certain examples, aspects of the operations of block 2110 may be performed by a connection configuration component as described with reference to FIGS. 10 through 13.

At block 2115 the UE 115 may determine a UE capability based at least in part on the first connection with the first base station. The operations of block 2115 may be performed according to the methods described with reference to FIGS. 1 through 9. In certain examples, aspects of the operations of block 2115 may be performed by a capability determination component as described with reference to FIGS. 10 through 13.

At block 2120 the UE 115 may transmit the UE capability to the first base station. The operations of block 2120 may be performed according to the methods described with reference to FIGS. 1 through 9. In certain examples, aspects of the operations of block 2120 may be performed by a transmitter as described with reference to FIGS. 10 through 13.

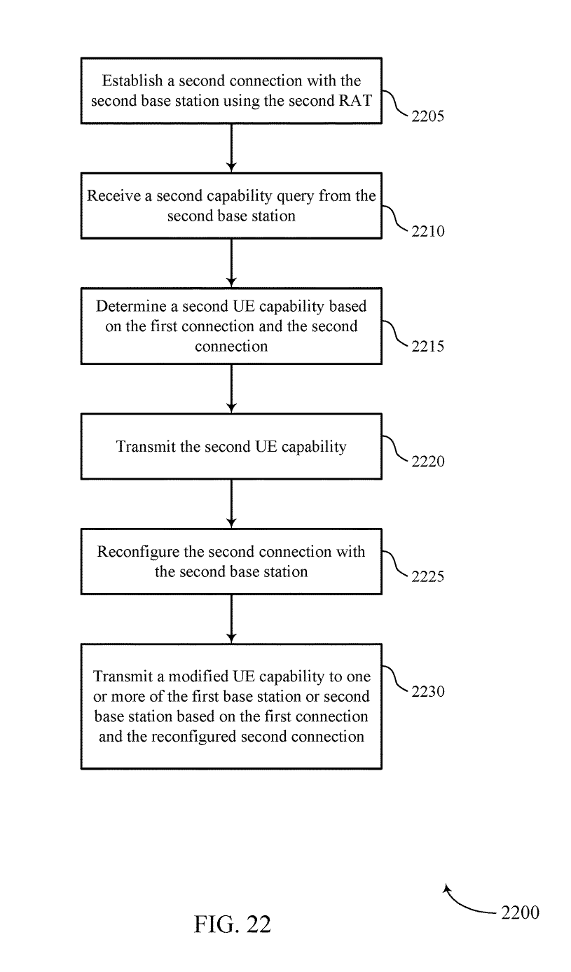

FIG. 22 shows a flowchart illustrating a method 2200 for UE capability determination for coordination across multiple RATs in accordance with various aspects of the present disclosure. The operations of method 2200 may be implemented by a UE 115 or its components as described herein. For example, the operations of method 2200 may be performed by a UE communications manager as described with reference to FIGS. 10 through 13. In some examples, a UE 115 may execute a set of codes to control the functional elements of the device to perform the functions described below. Additionally or alternatively, the UE 115 may perform aspects the functions described below using special-purpose hardware.

At block 2205 the UE 115, following the operations of FIG. 19, may establish a second connection with the second base station using the second RAT. The operations of block 2205 may be performed according to the methods described with reference to FIGS. 1 through 9. In certain examples, aspects of the operations of block 2205 may be performed by a connection establishment component as described with reference to FIGS. 10 through 13.

At block 2210 the UE 115 may receive a second capability query from the second base station. The operations of block 2210 may be performed according to the methods described with reference to FIGS. 1 through 9. In certain examples, aspects of the operations of block 2210 may be performed by a connection configuration component as described with reference to FIGS. 10 through 13.

At block 2215 the UE 115 may determine a second UE capability based at least in part on the first connection and the second connection. The operations of block 2215 may be performed according to the methods described with reference to FIGS. 1 through 9. In certain examples, aspects of the operations of block 2215 may be performed by a capability determination component as described with reference to FIGS. 10 through 13.

At block 2220 the UE 115 may transmit the second UE capability. The operations of block 2220 may be performed according to the methods described with reference to FIGS. 1 through 9. In certain examples, aspects of the operations of block 2220 may be performed by a transmitter as described with reference to FIGS. 10 through 13.

At block 2225 the UE 115 may reconfigure the second connection with the second base station. The operations of block 2225 may be performed according to the methods described with reference to FIGS. 1 through 9. In certain examples, aspects of the operations of block 2225 may be performed by a connection configuration component as described with reference to FIGS. 10 through 13. In some cases, the reconfiguration comprises one or more of an establishment of a second connection with the second base station using the second RAT that is different from the first RAT, an establishment of another connection with the first base station using the first RAT, or a reconfiguration of the first connection with the first base station using the first RAT.

At block 2230 the UE 115 may transmit a modified UE capability to one or more of the first base station or second base station based at least in part on the first connection and the reconfigured second connection. The operations of block 2230 may be performed according to the methods described with reference to FIGS. 1 through 9. In certain examples, aspects of the operations of block 2230 may be performed by a capability determination component as described with reference to FIGS. 10 through 13.

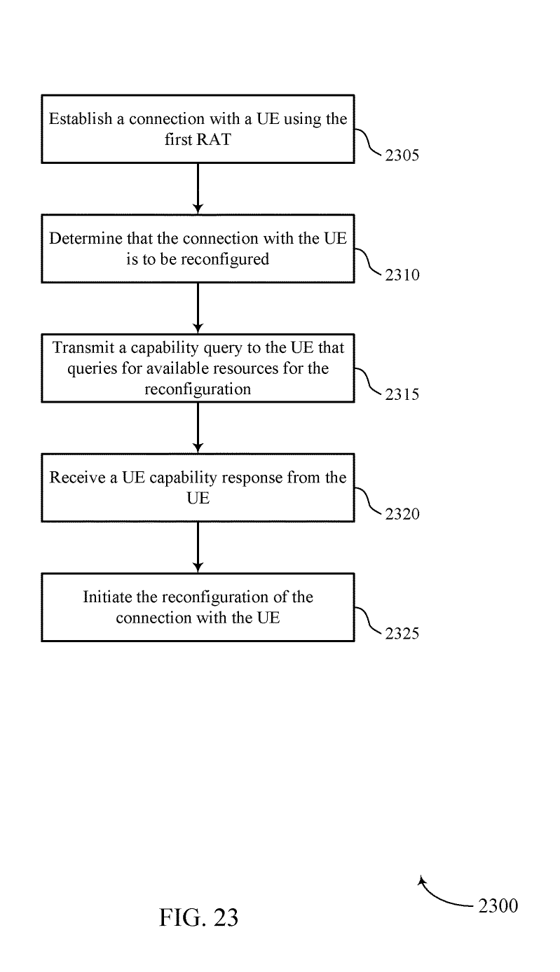

FIG. 23 shows a flowchart illustrating a method 2300 for UE capability determination for coordination across multiple RATs in accordance with various aspects of the present disclosure. The operations of method 2300 may be implemented by a base station 105 or its components as described herein. For example, the operations of method 2300 may be performed by a base station communications manager as described with reference to FIGS. 14 through 15 and 20. In some examples, a base station 105 may execute a set of codes to control the functional elements of the device to perform the functions described below. Additionally or alternatively, the base station 105 may perform aspects the functions described below using special-purpose hardware.

At block 2305 the base station 105 may establish a connection with a UE using the first RAT. The operations of block 2305 may be performed according to the methods described with reference to FIGS. 1 through 9. In certain examples, aspects of the operations of block 2305 may be performed by a connection establishment component as described with reference to FIGS. 14 through 15, and 20.

At block 2310 the base station 105 may determine that the connection with the UE is to be reconfigured. The operations of block 2310 may be performed according to the methods described with reference to FIGS. 1 through 9. In certain examples, aspects of the operations of block 2310 may be performed by a connection configuration component as described with reference to FIGS. 14 through 15, and 20.

At block 2315 the base station 105 may transmit a capability query to the UE that queries for available resources for the reconfiguration. The operations of block 2315 may be performed according to the methods described with reference to FIGS. 1 through 9. In certain examples, aspects of the operations of block 2315 may be performed by a capability query component as described with reference to FIGS. 14 through 15, and 20.

At block 2320 the base station 105 may receive a UE capability response from the UE. The operations of block 2320 may be performed according to the methods described with reference to FIGS. 1 through 9. In certain examples, aspects of the operations of block 2320 may be performed by a resource determination component as described with reference to FIGS. 14 through 15, and 20.

At block 2325 the base station 105 may initiate the reconfiguration of the connection with the UE. The operations of block 2325 may be performed according to the methods described with reference to FIGS. 1 through 9. In certain examples, aspects of the operations of block 2325 may be performed by a connection configuration component as described with reference to FIGS. 14 through 15, and 20. The reconfiguration of the connection with the UE may include, for example, configuring a second connection using a second RAT, reconfiguring the first connection with the first RAT, or any combination thereof.

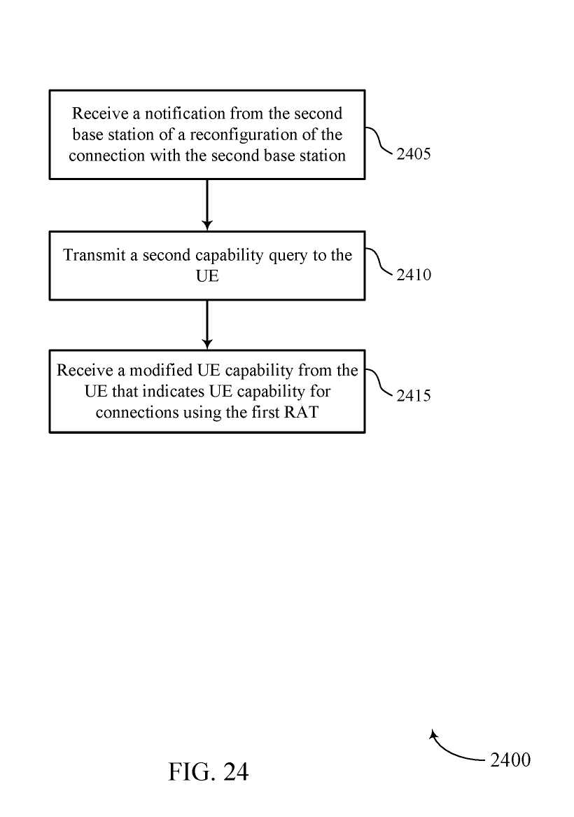

FIG. 24 shows a flowchart illustrating a method 2400 for UE capability determination for coordination across multiple RATs in accordance with various aspects of the present disclosure. The operations of method 2400 may be implemented by a base station 105 or its components as described herein. For example, the operations of method 2400 may be performed by a base station communications manager as described with reference to FIGS. 14 through 15, and 20. In some examples, a base station 105 may execute a set of codes to control the functional elements of the device to perform the functions described below. Additionally or alternatively, the base station 105 may perform aspects the functions described below using special-purpose hardware.

At block 2405 the base station 105 may receive a notification from the second base station of a reconfiguration of the connection with the second base station. The operations of block 2405 may be performed according to the methods described with reference to FIGS. 1 through 9. In certain examples, aspects of the operations of block 2405 may be performed by an inter-RAT coordination component as described with reference to FIGS. 14 through 15, and 20.

At block 2410 the base station 105 may transmit a second capability query to the UE. The operations of block 2410 may be performed according to the methods described with reference to FIGS. 1 through 9. In certain examples, aspects of the operations of block 2410 may be performed by a capability query component as described with reference to FIGS. 14 through 15, and 20.

At block 2415 the base station 105 may receive a modified UE capability from the UE that indicates UE capability for connections using the first RAT. The operations of block 2415 may be performed according to the methods described with reference to FIGS. 1 through 9. In certain examples, aspects of the operations of block 2415 may be performed by a resource determination component as described with reference to FIGS. 14 through 15, and 20.

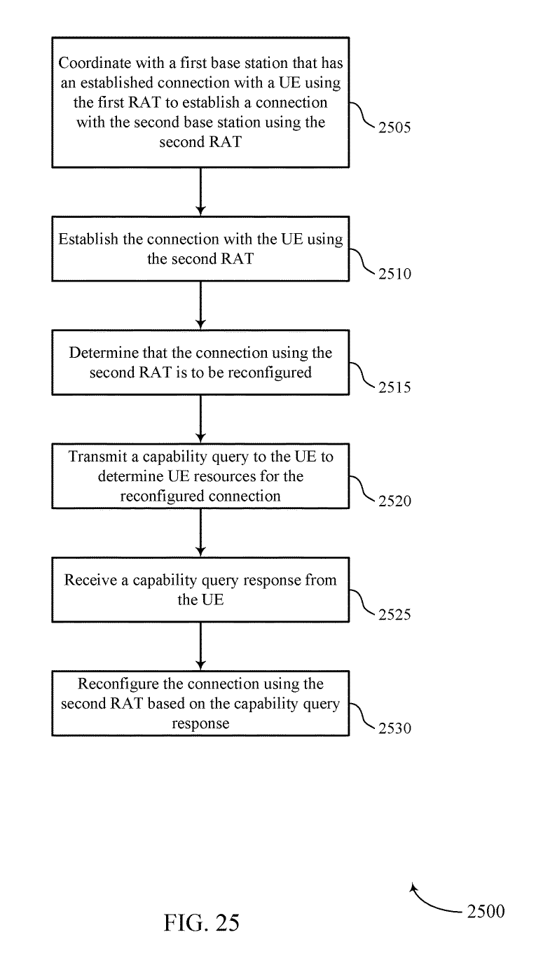

FIG. 25 shows a flowchart illustrating a method 2400 for UE capability determination for coordination across multiple RATs in accordance with various aspects of the present disclosure. The operations of method 2500 may be implemented by a base station 105 or its components as described herein. For example, the operations of method 2500 may be performed by a base station communications manager as described with reference to FIGS. 17 through 20. In some examples, a base station 105 may execute a set of codes to control the functional elements of the device to perform the functions described below. Additionally or alternatively, the base station 105 may perform aspects the functions described below using special-purpose hardware.

At block 2505 the base station 105 may coordinate with a first base station that has an established connection with a UE using the first RAT to establish a connection with the second base station using the second RAT. The operations of block 2505 may be performed according to the methods described with reference to FIGS. 1 through 9. In certain examples, aspects of the operations of block 2505 may be performed by an inter-RAT coordination component as described with reference to FIGS. 17 through 20.

At block 2510 the base station 105 may establish the connection with the UE using the second RAT. The operations of block 2510 may be performed according to the methods described with reference to FIGS. 1 through 9. In certain examples, aspects of the operations of block 2510 may be performed by a connection establishment component as described with reference to FIGS. 17 through 20.

At block 2515 the base station 105 may determine that the connection using the second RAT is to be reconfigured. The operations of block 2515 may be performed according to the methods described with reference to FIGS. 1 through 9. In certain examples, aspects of the operations of block 2515 may be performed by a resource determination component as described with reference to FIGS. 17 through 20.

At block 2520 the base station 105 may transmit a capability query to the UE to determine UE resources for the reconfigured connection. The operations of block 2520 may be performed according to the methods described with reference to FIGS. 1 through 9. In certain examples, aspects of the operations of block 2520 may be performed by a capability query component as described with reference to FIGS. 17 through 20.

At block 2525 the base station 105 may receive a capability query response from the UE. The operations of block 2525 may be performed according to the methods described with reference to FIGS. 1 through 9. In certain examples, aspects of the operations of block 2525 may be performed by a resource determination component as described with reference to FIGS. 17 through 20.

At block 2530 the base station 105 may reconfigure the connection using the second RAT based at least in part on the capability query response. The operations of block 2530 may be performed according to the methods described with reference to FIGS. 1 through 9. In certain examples, aspects of the operations of block 2530 may be performed by a connection configuration component as described with reference to FIGS. 17 through 20.

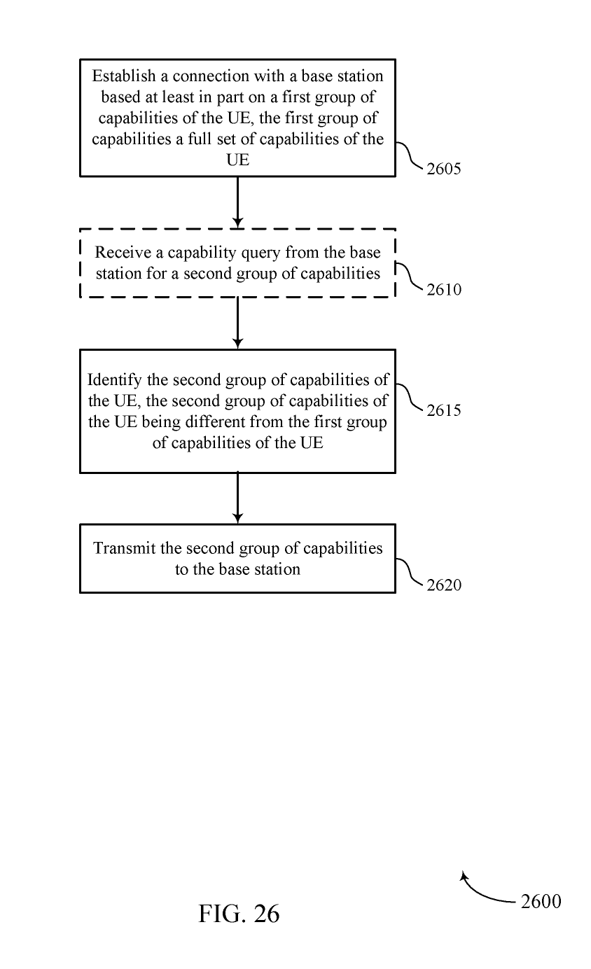

FIG. 26 shows a flowchart illustrating a method 2600 for UE capability determination for multiple radio capability groups in accordance with various aspects of the present disclosure. The operations of method 2600 may be implemented by a UE 115 or its components as described herein. For example, the operations of method 2600 may be performed by a UE communications manager as described with reference to FIGS. 10 through 13. In some examples, a UE 115 may execute a set of codes to control the functional elements of the device to perform the functions described below. Additionally or alternatively, the UE 115 may perform aspects of the functions described below using special-purpose hardware.

At block 2605 the UE 115 may establish a connection with a base station based at least in part on a first group of capabilities of the UE, the first group of capabilities being a full set of capabilities of the UE. The operations of block 2605 may be performed according to the methods described with reference to FIGS. 1 through 9. In certain examples, aspects of the operations of block 2605 may be performed by a connection establishment component as described with reference to FIGS. 10 through 13.

At optional block 2610 the UE 115 may receive a capability query from the base station for a second group of capabilities. The operations of block 2610 may be performed according to the methods described with reference to FIGS. 1 through 9. In certain examples, aspects of the operations of block 2610 may be performed by a capability determination component as described with reference to FIGS. 10 through 13.

At block 2615 the UE 115 may identify the second group of capabilities of the UE (e.g., in response to the capability query), the second group of capabilities of the UE being a subset of the first group of capabilities of the UE. The operations of block 2615 may be performed according to the methods described with reference to FIGS. 1 through 9. In certain examples, aspects of the operations of block 2615 may be performed by a capability determination component as described with reference to FIGS. 10 through 13.

At block 2620 the UE 115 may transmit the second group of capabilities to the base station. The operations of block 2620 may be performed according to the methods described with reference to FIGS. 1 through 9. In certain examples, aspects of the operations of block 2620 may be performed by a connection configuration component as described with reference to FIGS. 10 through 13.

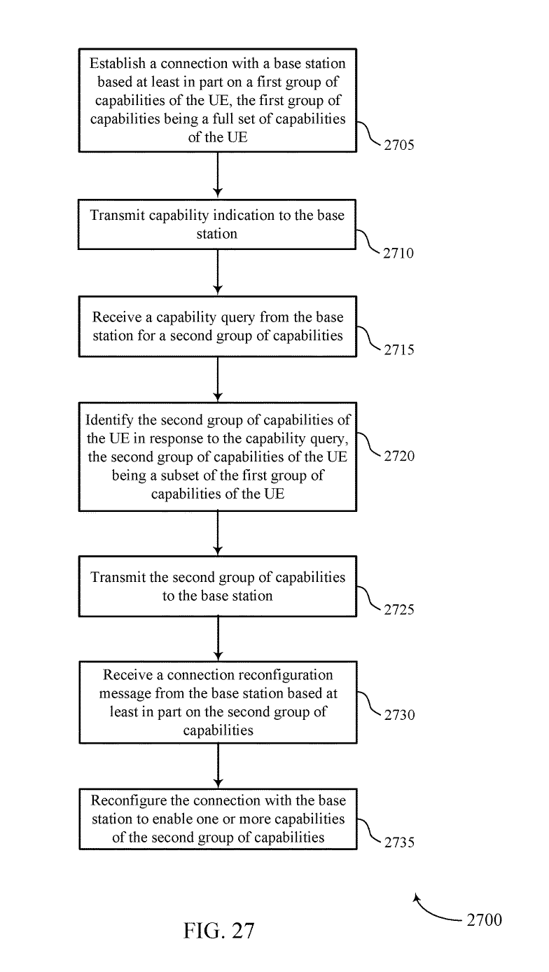

FIG. 27 shows a flowchart illustrating a method 2700 for UE capability determination for multiple radio capability groups in accordance with various aspects of the present disclosure. The operations of method 2700 may be implemented by a UE 115 or its components as described herein. For example, the operations of method 2700 may be performed by a UE communications manager as described with reference to FIGS. 10 through 13. In some examples, a UE 115 may execute a set of codes to control the functional elements of the device to perform the functions described below. Additionally or alternatively, the UE 115 may perform aspects of the functions described below using special-purpose hardware.

At block 2705 the UE 115 may establish a connection with a base station based at least in part on a first group of capabilities of the UE, the first group of capabilities being a full set of capabilities of the UE. The operations of block 2705 may be performed according to the methods described with reference to FIGS. 1 through 9. In certain examples, aspects of the operations of block 2705 may be performed by a connection establishment component as described with reference to FIGS. 10 through 13.

At block 2710 the UE 115 may transmit a capability indication to the base station including one or more other groups of capabilities that may be a subset of the full set of capabilities of the UE. The operations of block 2710 may be performed according to the methods described with reference to FIGS. 1 through 9. In certain examples, aspects of the operations of block 2710 may be performed by a capability determination component as described with reference to FIGS. 10 through 13.

At block 2715 the UE 115 may receive a capability query from the base station for a second group of capabilities. The operations of block 2715 may be performed according to the methods described with reference to FIGS. 1 through 9. In certain examples, aspects of the operations of block 2715 may be performed by a capability determination component as described with reference to FIGS. 10 through 13.

At block 2720 the UE 115 may identify the second group of capabilities of the UE in response to the capability query, the second group of capabilities of the UE being a subset of the first group of capabilities of the UE. In some cases the second group of capabilities may be based on current conditions of the UE (e.g., based on the available resources (e.g. RF chains, memory) and/or the current UE status (e.g. CPU load, temperature of the device). The operations of block 2720 may be performed according to the methods described with reference to FIGS. 1 through 9. In certain examples, aspects of the operations of block 2720 may be performed by a capability determination component as described with reference to FIGS. 10 through 13.

At block 2725 the UE 115 may transmit the second group of capabilities to the base station. The operations of block 2725 may be performed according to the methods described with reference to FIGS. 1 through 9. In certain examples, aspects of the operations of block 2725 may be performed by a connection configuration component as described with reference to FIGS. 10 through 13.

At block 2730 the UE 115 may receive a connection reconfiguration message from the base station based at least in part on the second group of capabilities. The operations of block 2730 may be performed according to the methods described with reference to FIGS. 1 through 9. In certain examples, aspects of the operations of block 2730 may be performed by a connection configuration component as described with reference to FIGS. 10 through 13.

At block 2735 the UE 115 may reconfigure the connection with the base station to enable one or more capabilities of the second group of capabilities. The operations of block 2735 may be performed according to the methods described with reference to FIGS. 1 through 9. In certain examples, aspects of the operations of block 2735 may be performed by a connection configuration component as described with reference to FIGS. 10 through 13.

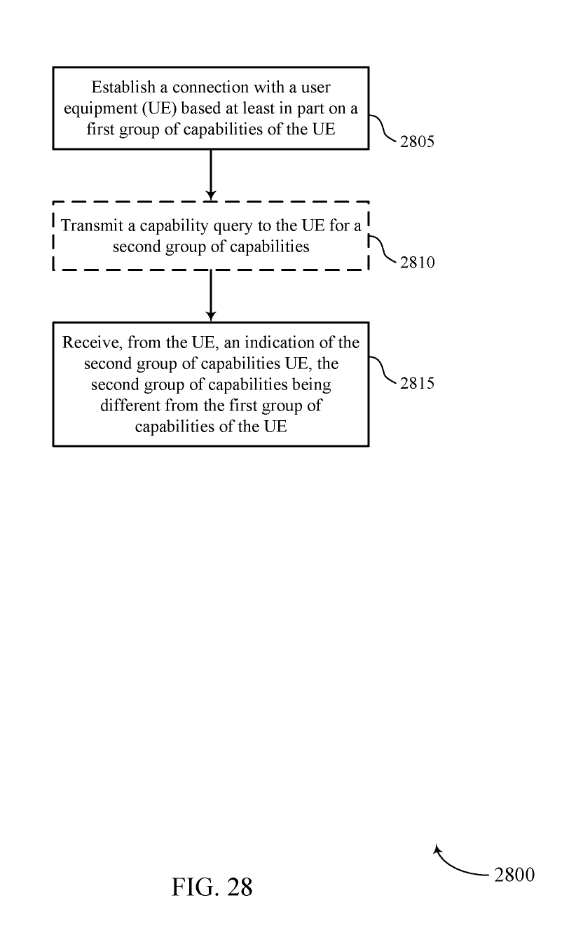

FIG. 28 shows a flowchart illustrating a method 2800 for UE capability determination for multiple radio capability groups in accordance with various aspects of the present disclosure. The operations of method 2800 may be implemented by a base station 105 or its components as described herein. For example, the operations of method 2800 may be performed by a base station communications manager as described with reference to FIGS. 14 through 16, and 20. In some examples, a base station 105 may execute a set of codes to control the functional elements of the device to perform the functions described below. Additionally or alternatively, the base station 105 may perform aspects of the functions described below using special-purpose hardware.

At block 2805 the base station 105 may establish a connection with a user equipment (UE) based at least in part on a first group of capabilities of the UE. The operations of block 2805 may be performed according to the methods described with reference to FIGS. 1 through 9. In certain examples, aspects of the operations of block 2805 may be performed by a connection establishment component as described with reference to FIGS. 14 through 16, and 20.

At optional block 2810 the base station 105 may transmit a capability query to the UE for a second group of capabilities. The operations of block 2810 may be performed according to the methods described with reference to FIGS. 1 through 9. In certain examples, aspects of the operations of block 2810 may be performed by a capability query component as described with reference to FIGS. 14 through 16, and 20.

At block 2815 the base station 105 may receive, from the UE, an indication of the second group of capabilities UE, the second group of capabilities being different from the first group of capabilities of the UE. The operations of block 2815 may be performed according to the methods described with reference to FIGS. 1 through 9. In certain examples, aspects of the operations of block 2815 may be performed by a capability query component as described with reference to FIGS. 14 through 16, and 20.

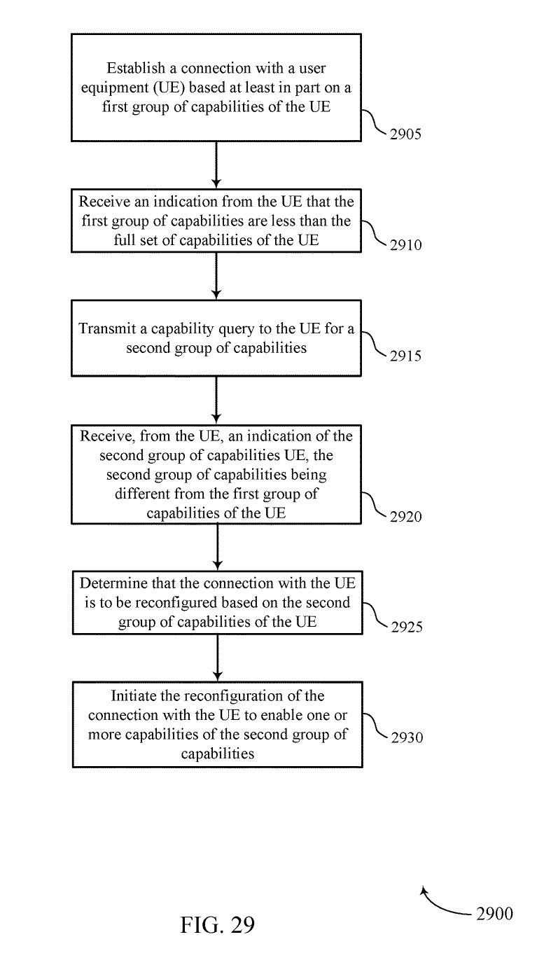

FIG. 29 shows a flowchart illustrating a method 2900 for UE capability determination for multiple radio capability groups in accordance with various aspects of the present disclosure. The operations of method 2900 may be implemented by a base station 105 or its components as described herein. For example, the operations of method 2900 may be performed by a base station communications manager as described with reference to FIGS. 14 through 16, and 20. In some examples, a base station 105 may execute a set of codes to control the functional elements of the device to perform the functions described below. Additionally or alternatively, the base station 105 may perform aspects of the functions described below using special-purpose hardware.

At block 2905 the base station 105 may establish a connection with a user equipment (UE) based at least in part on a first group of capabilities of the UE. The operations of block 2905 may be performed according to the methods described with reference to FIGS. 1 through 9. In certain examples, aspects of the operations of block 2905 may be performed by a connection establishment component as described with reference to FIGS. 14 through 16, and 20.

At block 2910 the base station 105 may receive an indication from the UE that the first group of capabilities are less than the full set of capabilities of the UE. The operations of block 2910 may be performed according to the methods described with reference to FIGS. 1 through 9. In certain examples, aspects of the operations of block 2910 may be performed by a capability query component as described with reference to FIGS. 14 through 16, and 20.

At block 2915 the base station 105 may transmit a capability query to the UE for a second group of capabilities. The operations of block 2915 may be performed according to the methods described with reference to FIGS. 1 through 9. In certain examples, aspects of the operations of block 2915 may be performed by a capability query component as described with reference to FIGS. 14 through 16, and 20.

At block 2920 the base station 105 may receive, from the UE, an indication of the second group of capabilities UE, the second group of capabilities being different from the first group of capabilities of the UE. The operations of block 2920 may be performed according to the methods described with reference to FIGS. 1 through 9. In certain examples, aspects of the operations of block 2920 may be performed by a capability query component as described with reference to FIGS. 14 through 16, and 20.

At block 2925 the base station 105 may determine that the connection with the UE is to be reconfigured based at least in part on the second group of capabilities of the UE. The operations of block 2925 may be performed according to the methods described with reference to FIGS. 1 through 9. In certain examples, aspects of the operations of block 2925 may be performed by a connection configuration component as described with reference to FIGS. 14 through 16, and 20.

At block 2930 the base station 105 may initiate the reconfiguration of the connection with the UE to enable one or more capabilities of the second group of capabilities. The operations of block 2930 may be performed according to the methods described with reference to FIGS. 1 through 9. In certain examples, aspects of the operations of block 2930 may be performed by a connection configuration component as described with reference to FIGS. 14 through 16.

It should be noted that the methods described above describe possible implementations, and that the operations may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communication systems 100 and 200 of FIGS. 1 and 13 may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary operation that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
establishing a connection with a base station based at least in part on a first group of capabilities of the UE, the first group of capabilities being a full set of capabilities of the UE;
identifying a second group of capabilities of the UE, the second group of capabilities of the UE being a subset of the first group of capabilities of the UE; and
transmitting an indication of the second group of capabilities to the base station.

2. The method of claim 1, further comprising:
receiving a connection reconfiguration message from the base station based at least in part on the second group of capabilities; and
reconfiguring the connection with the base station to enable one or more capabilities of the second group of capabilities.

3. The method of claim 1, further comprising:
receiving a capability query from the base station for a second group of capabilities, and wherein the identifying the second group of capabilities is based at least in part on the capability query.

4. The method of claim 3, wherein the capability query signals the type of capabilities to be provided by the UE.

5. The method of claim 1, further comprising:
transmitting an indication to the base station that the first group of capabilities of the UE is the full set of capabilities of the UE.

6. The method of claim 5, wherein the indication provides a number of capability groups that the UE can support.

7. The method of claim 5, wherein the indication provides a number of capability groups that the UE can support and an indication of a type of capabilities of each capability group other than the first group of capabilities.

8. The method of claim 1, wherein the full set of capabilities of the UE comprise a plurality of capability groups including one or more of:
UE capabilities per frequency band for a plurality of frequency bands;
UE capabilities per data rate for a plurality of data rates;
UE capabilities for one or more component carriers;
or any combination thereof.

9. The method of claim 8, wherein the full set of capabilities of the UE further comprise one or more of a capability to semi-statically change one or more of the plurality of capability groups or a capability to dynamically change one or more of the plurality of capability groups.

10. The method of claim 1, wherein a plurality of groups of capabilities are mapped to an index, and wherein the indication of the second group of capabilities includes an index value to indicate the second group of capabilities of the UE.

11. A method for wireless communication at a base station, comprising:
establishing a connection with a user equipment (UE) based at least in part on a first group of capabilities of the UE; and
receiving, from the UE, an indication of a second group of capabilities of the UE, the second group of capabilities being different from the first group of capabilities of the UE.

12. The method of claim 11, further comprising:
determining that the connection with the UE is to be reconfigured based at least in part on the second group of capabilities of the UE; and
initiating the reconfiguration of the connection with the UE to enable one or more capabilities of the second group of capabilities.

13. The method of claim 11, further comprising:
transmitting a capability query to the UE for the second group of capabilities, and wherein the indication of the second group of capabilities of the UE is provided responsive to the capability query.

14. The method of claim 13, wherein the capability query signals the type of capabilities to be provided by the UE.

15. The method of claim 11, further comprising:
receiving an indication from the UE that the first group of capabilities are less than a full set of capabilities of the UE.

16. The method of claim 15, wherein the indication provides a number of capability groups that the UE can support.

17. The method of claim 15, wherein the indication provides a number of capability groups that the UE can support and an indication of a type of capabilities of each capability group other than the first group of capabilities.

18. The method of claim 11, wherein a full set of capabilities of the UE comprise a plurality of capability groups including one or more of:
UE capabilities per frequency band for a plurality of frequency bands;
UE capabilities per data rate for a plurality of data rates;
UE capabilities for one or more component carriers;
or any combination thereof.

19. The method of claim 18, wherein the full set of capabilities of the UE further comprise one or more of a capability to semi-statically change one or more of the plurality of capability groups or a capability to dynamically change one or more of the plurality of capability groups.

20. The method of claim 11, wherein a plurality of groups of capabilities are mapped to an index, and wherein the indication of the second group of capabilities includes an index value to indicate the second group of capabilities of the UE.

21. An apparatus for wireless communication at a user equipment (UE), comprising:
means for establishing a connection with a base station based at least in part on a first group of capabilities of the UE, the first group of capabilities being a full set of capabilities of the UE;
means for identifying a second group of capabilities of the UE, the second group of capabilities of the UE being a subset of the first group of capabilities of the UE; and
means for transmitting an indication of the second group of capabilities to the base station.

22. The apparatus of claim 21, further comprising:
means for receiving a connection reconfiguration message from the base station based at least in part on the second group of capabilities; and
means for reconfiguring the connection with the base station to enable one or more capabilities of the second group of capabilities.

23. The apparatus of claim 21, further comprising:
means for receiving a capability query from the base station for a second group of capabilities, and wherein the identifying the second group of capabilities is based at least in part on the capability query.

24. The apparatus of claim 21, wherein the full set of capabilities of the UE comprise a plurality of capability groups including one or more of:
UE capabilities per frequency band for a plurality of frequency bands;
UE capabilities per data rate for a plurality of data rates;
UE capabilities for one or more component carriers;
or any combination thereof.

25. The apparatus of claim 24, wherein the full set of capabilities of the UE further comprise one or more of a capability to semi-statically change one or more of the plurality of capability groups or a capability to dynamically change one or more of the plurality of capability groups.

26. An apparatus for wireless communication at a base station, comprising:
means for establishing a connection with a user equipment (UE) based at least in part on a first group of capabilities of the UE; and
means for receiving, from the UE, an indication of a second group of capabilities of the UE, the second group of capabilities being different from the first group of capabilities of the UE.

27. The apparatus of claim 26, further comprising:
means for determining that the connection with the UE is to be reconfigured based at least in part on the second group of capabilities of the UE; and
means for initiating the reconfiguration of the connection with the UE to enable one or more capabilities of the second group of capabilities.

28. The apparatus of claim 26, further comprising:
means for transmitting a capability query to the UE for the second group of capabilities, and wherein the indication of the second group of capabilities of the UE is provided responsive to the capability query.

29. The apparatus of claim 26, wherein a full set of capabilities of the UE comprise a plurality of capability groups including one or more of:
UE capabilities per frequency band for a plurality of frequency bands;
UE capabilities per data rate for a plurality of data rates;
UE capabilities for one or more component carriers;
or any combination thereof.

30. The apparatus of claim 29, wherein the full set of capabilities of the UE further comprise one or more of a capability to semi-statically change one or more of the plurality of capability groups or a capability to dynamically change one or more of the plurality of capability groups.
